(19) United States
(12) Patent Application Publication
(10) Pub. No.: US 2009/0130346 A1
(43) Pub. Date: May 21, 2009

(54) Magnetic Recording Medium, Production Process Thereof, and Magnetic Recording and Reproducing Apparatus

(75) Inventors: Hiroshi Osawa, Chiba-shi (JP); Kenji Shimizu, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 11/921,240

(22) PCT Filed: Jul. 28, 2006
(86) PCT No.: PCT/JP2006/315439

§ 371 Date: Nov. 29, 2007

Related U.S. Application Data
(60) Provisional application No. 60/709,101, filed on Aug. 18, 2005.

(30) Foreign Application Priority Data
Aug. 11, 2005 (JP) 2005-233009

(51) Int. Cl. G11B 5/66; G11B 5/74

(52) U.S. Cl. 428/31; 427/131; 360/131

(57) ABSTRACT

In a magnetic recording medium which is able to cope with a higher recording density, there is provided a magnetic recording medium which has a higher retentivity and a lower noise, a production process thereof, and a magnetic recording and reproducing apparatus. The magnetic recording medium is characterized in that at least a non-magnetic base layer, a non-magnetic intermediate layer, a magnetic layer, and a protective layer are laminated in this order on a non-magnetic substrate, and at least one of the layers of the non-magnetic base layer is configured by a WX-based alloy or a MoX-based alloy (X═Zr, Nb, Hf, Ta).

### CROSS-REFERENCE TO RELATED APPLICATION

The present application is filed under 35 U.S.C. § 111 (a), and claims benefit, pursuant to 35 U.S.C. § 119(e)(1), of the filing dates of Provisional Application No. 60/709,101 filed Aug. 18, 2006, pursuant to 35 U.S.C. § 111(b). Priority is claimed to Japanese application No. 2005-233009, filed Aug. 11, 2005, which is incorporated herein by reference.

### TECHNICAL FIELD

The present invention relates to a magnetic recording medium used in hard disk devices and the like, a production process of the magnetic recording medium, and a magnetic recording and reproducing apparatus.

### BACKGROUND ART

The recording density of a hard disk device (HDD), which is a magnetic recording and reproducing apparatus, has reached 100 Gbits/in², and the recording density is expected to continuously increase at a rate of 30% per year. Therefore, magnetic recording heads and magnetic recording media which are suitable for attaining high recording density are now under development. Magnetic recording media employed in hard disk devices are required to have high recording density, and accordingly, demand has arisen for improvement of coercive force and reduction of medium noise. Most magnetic recording media employed in hard disk devices have a structure including a magnetic recording medium substrate on which a metallic film is stacked through sputtering. Aluminum substrates and glass substrates are widely employed for producing magnetic recording media. An aluminum substrate is produced through the following process: an Ni—P-based alloy film (thickness: about 10 μm) is formed through electroless plating on an Al—Mg alloy substrate base which has undergone mirror polishing, and the surface of the Ni—P-based alloy film is subjected to mirror polishing. Glass substrates are classified into two types; i.e., amorphous glass substrates and glass ceramic substrates. When either of these two types of glass substrate is employed to produce a magnetic recording medium, the substrate is subjected to mirror polishing.

In general, a magnetic recording medium employed to produce a hard disk device includes a non-magnetic substrate; a non-magnetic base layer (formed of, for example, Cr, a Cr-based alloy, or an Ni—Al-based alloy); a non-magnetic intermediate layer (formed of, for example, a Co—Cr-based alloy or a Co—Cr—Ta-based alloy); a magnetic layer (formed of, for example, a Co—Cr—Pt—Ta-based alloy or a Co—Cr—Pt—B-based alloy); a protective film (formed of, for example, carbon), the layers and film being sequentially formed on the substrate; and a lubrication film containing a liquid lubricant and formed on the protective film.

The Co alloy employed in such a magnetic layer (e.g., a Co—Cr—Pt—Ta-based alloy or a Co—Cr—Pt—B-based alloy) contains Co as a primary component. Such a Co alloy has a hexagonal close-packed (hcp) structure in which the C-axis is an easy-magnetization axis. Magnetic recording media are classified into a longitudinal recording type and a perpendicular recording type, in which the magnetic layer is generally formed of a Co alloy. In a longitudinal recording medium, the C-axis of the Co alloy is oriented in parallel with the non-magnetic substrate, whereas in a perpendicular recording medium, the C-axis of the Co alloy is oriented vertical to the non-magnetic substrate. Therefore, in a longitudinal recording medium, the (10•0) plane or the (11•0) plane of the Co alloy preferably serves as a longitudinal recording plane.

Production of magnetic recording media of high recording density requires reduction of medium noise. The below-mentioned Non-Patent Document 1 describes, by use of a theoretical formula, that reduction of medium noise is effectively attained by reducing the average crystal grain size of a Co alloy and the Co-alloy crystal grain size distribution. The below-mentioned Non-Patent Document 2 describes that a magnetic recording medium which has reduced medium noise and is suitable for high-density recording can be produced by reducing the average crystal grain size of a Co alloy and the Co-alloy crystal grain size distribution. Thus, a critical point for medium noise reduction is to reduce the average crystal grain size of a Co alloy and the Co-alloy crystal grain size distribution. Since a Co alloy layer is epitaxially grown on a Cr alloy layer, one can easily conceive that reduction of the average crystal grain size of the Cr alloy and the Cr-alloy crystal grain size distribution would contribute to reduction of the average crystal grain size of the Co alloy and the Co-alloy crystal grain size distribution.

As has been reported, addition of various elements to Cr results in improvement of properties. The below-mentioned Patent Document 1 discloses that addition of Ti to Cr is effective. The below-mentioned Patent Document 2 discloses that addition of V to Cr is effective. The below-mentioned Patent Document 3 discloses that addition of Mo or W to Cr is effective. The below-mentioned Patent Documents 4 and 5 disclose that formation of a base layer from two layers containing Cr as a primary component and containing different additive elements is effective. The below-mentioned Patent Document 6 discloses that addition of oxygen or nitrogen to a non-magnetic base layer containing Cr as a primary component is effective.

### [Patent Document 1]

Japanese Patent Application Laid-Open (kokai) No. 63-197018

### [Patent Document 2]

Specification of U.S. Pat. No. 4,652,499

### [Patent Document 3]

Japanese Patent Application Laid-Open (kokai) No. 63-187416

### [Patent Document 4]

Japanese Patent Application Laid-Open (kokai) No. 7-73427

### [Patent Document 5]

Japanese Patent Application Laid-Open (kokai) No. 2000-322732

### [Patent Document 6]

Japanese Patent Application Laid-Open (kokai) No. 11-283235

### [Patent Document 7]

Specification of European Patent No. 0704839

### [Patent Document 8]

Japanese Patent Application Laid-Open (kokai) No. 2003-123243

### [Non-Patent Document 1]

J. Appl. Phys. Vol. 87, pp. 5365-5370

### [Non-Patent Document 2]

J. Appl. Phys. Vol. 87, pp. 5407-5409

### DISCLOSURE OF THE INVENTION

### Problems to be Solved by the Invention

As described above, a non-magnetic base layer contains a Cr alloy as a primary component. Techniques which have been employed for medium noise reduction through improvement of a non-magnetic base layer include reduction of the average crystal grain size of a Cr alloy, improvement of crystal orientation of a Cr alloy, and lattice matching of a Cr alloy with a Co alloy. The Cr alloy employed in a non-magnetic base layer contains Cr as a primary component, and therefore properties of the Cr alloy depend mainly on the properties inherent in Cr. This results in narrow range of freedom in designing a non-magnetic base layer of a magnetic recording medium.

Several techniques have been proposed to employ a Cr alloy in a non-magnetic base layer. Patent Document 7 proposes a technique for employing an alloy having a B2 structure (e.g., AlNi, AlCo, or AlFe) in a non-magnetic base film, thereby reducing the size of crystal grains contained in a magnetic film, and attaining noise reduction. However, employment of an Al—Ni alloy encounters difficulty in attaining high coercive force, and employment of an Al—Co alloy encounters difficulty in attaining high coercive force and squareness ratio. Therefore, this technique may result in low reproduction output, leading to problems in high-density recording. Patent Document 8 proposes a technique for forming a film of Mo, W, an MoTi-based alloy, or a WTi-based alloy on an alignment-regulating layer formed of an oxide such as MgO, thereby attaining noise reduction. However, this technique fails to attain a recording density in excess of 50 Gbits/in², since elemental Mo or W, an MoTi-based alloy, or a WTi-based alloy imposes a limitation on noise reduction.

In view of the foregoing, an object of the present invention is to provide a magnetic recording medium which has higher coercive force and lower noise, and which can attain higher recording density. Another object of the present invention is to provide a process for producing the medium. Still another object of the present invention is to provide a magnetic recording and reproducing apparatus.

### Means for Solving the Problems

In order to solve the aforementioned problems, the present inventors have conducted extensive studies, and as a result have found that when a non-magnetic base layer is formed of a WX-based alloy or an MoX-based alloy (X═Zr, Nb, Hf, or Ta), properties of a magnetic recording and reproducing apparatus can be improved. The present invention has been accomplished on the basis of this finding. Also, the present inventors have found that when a non-magnetic intermediate layer is formed of Ru or an RuY-based alloy (Y═Ti, Nb, Mo, Rh, Ta, W, Re, Ir, or Pt), properties of a magnetic recording and reproducing apparatus can be improved. The present invention has been accomplished on the basis of this finding. Accordingly, the present invention is directed to the following.

(1) A magnetic recording medium comprising a non-magnetic substrate; and, on the substrate, at least a non-magnetic base layer, a non-magnetic intermediate layer, a magnetic layer, and a protective layer, the layers being provided in this sequence, characterized in that at least one layer constituting the non-magnetic base layer is formed of a WX-based alloy or an MoX-based alloy (X═Zr, Nb, Hf, or Ta).

(2) A magnetic recording medium comprising a non-magnetic substrate; and, on the substrate, at least a non-magnetic base layer, a non-magnetic intermediate layer, a stabilization layer, a non-magnetic coupling layer, a magnetic layer, and a protective layer, the layers being provided in this sequence, and the stabilization layer being antiferromagnetically coupled with the magnetic layer, characterized in that at least one layer constituting the non-magnetic base layer is formed of a WX-based alloy or an MoX-based alloy (X═Zr, Nb, Hf, or Ta).

(3) A magnetic recording medium as described in (1) or (2), wherein at least one layer constituting the non-magnetic intermediate layer is formed of Ru or an RuY alloy (Y═Ti, Nb, Mo, Rh, Ta, W, Re, Ir, or Pt).

(4) A magnetic recording medium as described in any one of (1) through (3), wherein the WX-based alloy has a W content of 50 to 99 at %, and an X content of 1 to 50 at %.

(5) A magnetic recording medium as described in any one of (1) through (3), wherein the MoX-based alloy has an Mo content of 50 to 99 at %, and an X content of 1 to 50 at %.

(6) A magnetic recording medium as described in (3), wherein the RuY-based alloy has an Ru content of 20 to 99 at %, and an X content of 1 to 80 at %.

(7) A magnetic recording medium as described in any one of (2) through (6), wherein the non-magnetic coupling layer is formed of any one species selected from among Ru, Rh, Ir, Cr, Re, an Ru-based alloy, an Rh-based alloy, an Ir-based alloy, a Cr-based alloy, and an Re-based alloy, and the non-magnetic coupling layer has a thickness of 0.5 to 1.5 nm.

(8) A magnetic recording medium as described in any one of (2) through (7), wherein the stabilization layer is formed of one or more species selected from among a CoCrZr-based alloy, a CoCrTa-based alloy, a CoRu-based alloy, a CoCrRu-based alloy, a CoCrPtZr-based alloy, a CoCrPtTa-based alloy, a CoPtRu-based alloy, and a CoCrPtRu-based alloy.

(9) A magnetic recording medium as described in any one of (1) through (8), wherein the non-magnetic base layer has a multi-layer structure including a layer formed of Cr or an Cr alloy containing Cr and one or more species selected from among Ti, Mo, Al, Ta, W, Ni, B, Si, Mn, and V, and a layer formed of a WX-based alloy or an MoX-based alloy (X═Zr, Nb, Hf, or Ta).

(10) A magnetic recording medium as described in any one of (1) through (9), wherein the magnetic layer is formed of one or more species selected from among a CoCrTa-based alloy, a CoCrPtTa-based alloy, a CoCrPtB-based alloy, and a CoCrPtBM-based alloy (M: one or more species selected from among Ta, Cu, and Ag).

(11) A magnetic recording medium as described in any one of (1) through (10), wherein the non-magnetic substrate is any one species selected from among a glass substrate and a silicon substrate.

(12) A magnetic recording medium as described in any one of (1) through (10), wherein the non-magnetic substrate includes a substrate base formed of any one species selected from among Al, an Al alloy, glass, and silicon, and an NiP or NiP alloy film formed on the surface of the substrate base.

(13) A magnetic recording medium as described in any one of (1) through (12), wherein the layer formed of a WX-based alloy or an MoX-based alloy (X═Zr, Nb, Hf, or Ta) has a thickness of 0.5 to 12 nm.

(14) A process for producing a magnetic recording medium comprising a non-magnetic substrate; and, on the substrate, at least a non-magnetic base layer, a non-magnetic intermediate layer, a magnetic layer, and a protective layer, the layers being provided in this sequence, characterized in that the process comprises forming at least one layer constituting the non-magnetic base layer from a WX-based alloy or an MoX-based alloy (X═Zr, Nb, Hf, or Ta).

(15) A process for producing a magnetic recording medium comprising a non-magnetic substrate; and, on the substrate, at least a non-magnetic base layer, a stabilization layer, a non-magnetic coupling layer, a magnetic layer, and a protective layer, the layers being provided in this sequence, and the stabilization layer being antiferromagnetically coupled with the magnetic layer, characterized in that the process comprises forming at least one layer constituting the non-magnetic base layer from a WX-based alloy or an MoX-based alloy (X═Zr, Nb, Hf, or Ta).

(16) A magnetic recording and reproducing apparatus characterized by comprising a magnetic recording medium as described in any one of (1) through (13), and a magnetic head for recording of data onto the medium and for reproduction of the data therefrom.

### EFFECTS OF THE INVENTION

The magnetic recording medium of the present invention includes a non-magnetic substrate; and, on the substrate, at least a non-magnetic base layer, a non-magnetic intermediate layer (a stabilization layer and a non-magnetic coupling layer may be provided between the non-magnetic intermediate layer and a magnetic layer), a magnetic layer, and a protective layer, the layers being provided in this sequence. A characteristic feature of the magnetic recording medium resides in that at least one layer constituting the non-magnetic base layer is formed of a WX-based alloy or an MoX-based alloy (X═Zr, Nb, Hf, or Ta). Therefore, the non-magnetic base layer has a large lattice constant, and the alloy constituting the non-magnetic intermediate layer is sufficiently epitaxially grown on the base layer, whereby noise reduction can be attained, and the resultant magnetic recording medium exhibits excellent properties and is suitable for high-density recording. In addition, when at least one layer constituting the non-magnetic intermediate layer is formed of Ru or an RuY-based alloy (Y═Ti, Nb, Mo, Rh, Ta, W, Re, Ir, or Pt), properties of the medium can be further improved.

### BRIEF DESCRIPTION OF THE DRAWINGS

FIG. 1 is a cross-sectional view showing a first embodiment of the perpendicular magnetic recording medium of the present invention.

FIG. 2 is a cross-sectional view showing a second embodiment of the perpendicular magnetic recording medium of the present invention.

FIG. 3 shows the configuration of an example of the magnetic recording and reproducing apparatus of the present invention.

### BRIEF DESCRIPTION OF REFERENCE NUMERALS

1 Non-magnetic substrate, 2 Non-magnetic base layer, 3 Non-magnetic intermediate layer, 4 Magnetic layer, 5 Protective layer, 6 Lubrication layer,
7 Stabilization layer, 8 Non-magnetic coupling layer, 10 Magnetic recording medium, 11 Magnetic recording medium, 12 Magnetic recording and reproducing apparatus, 13 Medium-driving section, 14 Magnetic head,
15 Head-driving section, 16 Recorded/reproduced-signal-processing system.

### BEST MODE FOR CARRYING OUT THE INVENTION

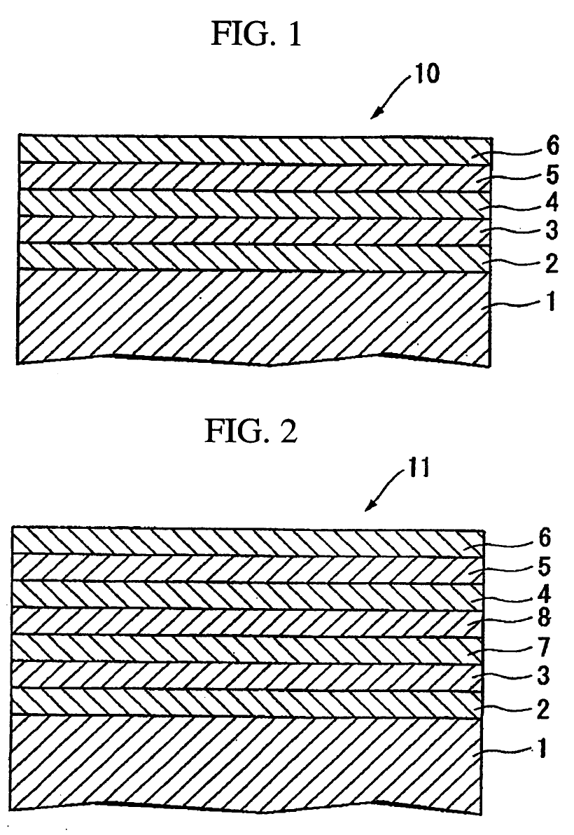

FIG. 1 shows a first embodiment of the magnetic recording medium of the present invention. The magnetic recording medium 10 shown in FIG. 1 includes a non-magnetic substrate 1, a non-magnetic base layer 2, a non-magnetic intermediate layer 3, a magnetic layer 4, a protective layer 5, and a lubrication layer 6, the layers being sequentially formed on the substrate 1.

FIG. 2 shows a second embodiment of the magnetic recording medium of the present invention. The magnetic recording medium 11 shown in FIG. 2 includes a non-magnetic substrate 1, a non-magnetic base layer 2, a non-magnetic intermediate layer 3, a stabilization layer 7, a non-magnetic coupling layer 8, a magnetic layer 4, a protective layer 5, and a lubrication layer 6, the layers being sequentially formed on the substrate 1. The layer structure shown in FIG. 2 is a technique devised for preventing thermal decay of the magnetic layer. In the magnetic recording medium employing this technique, the aforementioned two magnetic layers 4 are magnetized in opposite directions, and thus the thickness of a portion which participates in magnetic recording and reproduction becomes substantially smaller than that of the entirety of the recording layer. Therefore, SNR can be improved. Meanwhile, the volume of crystal grains contained in the entirety of the recording layer becomes large, and thus thermal stability can be improved.

In general, media employing the aforementioned technique are called “AFC media (Antiferromagnetically-coupled media)” or “SFM (Synthetic ferrimagnetic media).” Herein, these media are collectively called “AFC media.”

In the present invention, the non-magnetic substrate 1 may be a substrate including a substrate base formed of a metallic material such as Al or an Al alloy, and an NiP or NiP alloy film formed on the substrate base. The non-magnetic substrate 1 may be a substrate formed of a non-metallic material such as glass, ceramic, silicon, silicon carbide, carbon, or resin; or may be a substrate including a substrate base formed of such a non-metallic material, and an NiP or NiP alloy film formed on the substrate base. The non-metallic material is preferably any one species selected from among glass and silicon, from the viewpoint of surface smoothness. Particularly, the non-metallic material is preferably glass, from the viewpoints of cost and durability. The glass to be employed may be glass ceramic or amorphous glass. The amorphous glass may be general-purpose glass such as soda-lime glass, aluminoborosilicate glass, or aluminosilicate glass. The glass ceramic may be lithium-based glass ceramic. The ceramic material for the substrate may be a general-purpose sintered compact predominantly containing aluminum oxide, silicon nitride, or the like; or fiber-reinforced material thereof. In order to increase recording density, the flying height of a magnetic head must be reduced. Therefore, preferably, the non-magnetic substrate 1 has enhanced surface smoothness. Specifically, the non-magnetic substrate 1 preferably has an average surface roughness (Ra) of 2 nm or less, more preferably 1 nm or less.

The non-magnetic substrate 1 preferably has texture lines formed on the surface thereof through texturing. Texturing is carried out such that the average surface roughness of the substrate is preferably 0.1 nm or more and 0.7 nm or less (more preferably 0.1 nm or more and 0.5 nm or less, much more preferably 0.1 nm or more and 0.35 nm or less). Texture lines are preferably formed so as to run along almost a tangential direction of the substrate, from the viewpoint of enhancement of magnetic anisotropy of the magnetic recording medium in a tangential direction thereof. The non-magnetic substrate 1 preferably has, on its surface, a micro-waviness (Wa) of 0.3 nm or less (more preferably 0.25 nm or less). From the viewpoint of flying stability of a magnetic head, the average surface roughness (Ra) of at least one of an edge portion and a side portion of a chamfer section of the end surface of the non-magnetic substrate 1 is preferably regulated to 10 nm or less (more preferably 9.5 nm or less). The micro-waviness (Wa) may be determined as an average surface roughness as measured within a measurement range of 80 μm by use of, for example, a surface roughness measuring apparatus P-12 (product of KLM-Tencor).

The non-magnetic base layer 2 is formed on the non-magnetic substrate. At least one layer constituting the non-magnetic base layer 2 is formed of a WX-based alloy or an MoX-based alloy (X═Zr, Nb, Hf, or Ta).

In the present invention, the WX-based alloy employed in the non-magnetic base layer 2 has a W content of 50 to 99 at %, and an X content of 1 to 50 at %. When the X content is less than 1 at %, the effect of addition of X fails to be obtained, whereas when the X content exceeds 50 at %, crystal grains in a WX-based alloy film become large in size, leading to an increase in noise, which is not preferred.

In the present invention, the MoV-based alloy employed in the non-magnetic base layer 2 has an Mo content of 50 to 99 at %, and an X content of 1 to 50 at %. When the X content is less than 1 at %, the effect of addition of X fails to be obtained, whereas when the X content exceeds 50 at %, crystal grains in an MoX-based alloy film become large in size, leading to an increase in noise, which is not preferred.

Addition of an element such as W, Mo, or V to Cr exhibits the effect of increasing the lattice constant of Cr, and this technique has been conventionally widely employed for lattice matching of Cr with a Co alloy. However, in recent years, demand has arisen for further increasing the Cr lattice constant, since the lattice constant of a Co alloy has been increased through addition of an increased amount of Pt to the Co alloy, or an Ru alloy, which has a lattice constant larger than that of Co, has been employed. In order to meet this demand, the present inventors proposed, in Japanese Patent Application No. 2005-172199, employment of an alloy of body-centered cubic crystal structure having a lattice constant as large as 3.05 to 3.20 Å. The present inventors have further extended this idea, and have found that combination of Ru or an RuY alloy (Y═Nb, Mo, Rh, Ta, W, Re, Ir, or Pt) with a WX-based or MoX-based alloy (X═Zr, Nb, Hf, or Ta) which respectively increases the lattice constant of W or Mo can attain optimum lattice matching.

In the present invention, the WX-based or MoX-based alloy (X═Zr, Nb, Hf, or Ta) employed in the non-magnetic base layer 2 may contain additive elements exhibiting an auxiliary effect. Examples of the additive elements include B, C, Al, Si, Cr, Mn, Cu, Ru, and Re. The total amount of the additive elements is preferably 20 at % or less. When the total amount exceeds 20 at %, the aforementioned effects of the alignment-regulating film are lowered. The lower limit of the total amount is 0.1 at %. When the total amount is less than 0.1 at %, the effect of the additive elements fails to be obtained. Particularly, addition of B exhibits significant effects, and employment of a WXB alloy or an MoXB alloy greatly contributes to noise reduction.

In the present invention, when the non-magnetic base layer 2 is formed of at least two layers, one layer of the layer 2 that comes into contact with the non-magnetic intermediate layer 3 is formed of a WX-based alloy or an MoX-based alloy, and the other layer(s) may contain a Cr layer or a Cr alloy layer containing one or more species selected from among Ti, Mo, Al, Ta, W, Ni, B, Si, Mn, and V.

In the present invention, the thickness of the non-magnetic base layer 2 preferably falls within a range of 10 Å to 300 Å (1 to 30 nm). When the thickness of the non-magnetic base layer 2 is less than 10 Å, the crystal orientation of the non-magnetic base layer 2 becomes insufficient, and thus coercive force is lowered, whereas when the thickness of the non-magnetic base layer 2 exceeds 300 Å, the tangential magnetic anisotropy of the magnetic layer 4 is lowered. In order to enhance the coercive force and squareness ratio of the magnetic layer 4, preferably, the thickness of the WX-based or MoX-based alloy layer is regulated to fall within a range of 5 Å to 120 Å (0.5 to 12 nm) (more preferably 2 to 6 nm), and the thickness of the other layer(s) constituting the non-magnetic base layer 2 (e.g., Cr layer or Cr alloy layer) is regulated to fall within a range of 5 Å to 100 Å (0.5 to 10 nm). Preferably, a preferential plane of the WX-based or MoX-based alloy (X═Zr, Nb, Hf, or Ta) contained in the non-magnetic base layer 2 is a (100) plane. With this crystal orientation, the (110) plane of the Co alloy in the magnetic layer 4 formed atop the non-magnetic base layer 2 is more preferential, leading to improvement of magnetic characteristics (e.g., coercive force (Hc)) and recording and reproduction characteristics (e.g., SNR).

In the present invention, at least one layer constituting the non-magnetic intermediate layer 3 is formed of Ru or an RuY alloy (Y═Ti, Nb, Mo, Rh, Ta, W, Re, Ir, or Pt). In the present invention, the Ru or RuY alloy employed in the non-magnetic intermediate layer has an Ru content of 20 to 99 at %, and an X content of 1 to 80 at %. When the Y content is less than 1 at %, the effect of addition of Y fails to be obtained, whereas when the Y content exceeds 80 at %, crystal grains in an RuY-based alloy film become large in size, leading to an increase in noise, which is not preferred. More preferably, Y is Re, Ir, or Rh. In such a case, the Ru content is 20 to 80 at %, and the X content is 20 to 80 at %. In the case where Y is Ti, Nb, Mo, Ta, W, or Pt, the Ru content is 50 to 99 at %, and the X content is 1 to 50 at %.

The thickness of the non-magnetic intermediate layer 3 preferably falls within a range of 10 Å to 100 Å. When the thickness of the non-magnetic intermediate layer 3 is less than 10 Å, the crystal orientation of the non-magnetic base layer 2 becomes insufficient, and thus coercive force is lowered, whereas when the thickness of the non-magnetic intermediate layer 3 exceeds 100 Å, crystal grains become large, leading to an increase in noise.

In the present invention, preferably, the magnetic layer 4 contains any one species selected from among a Co—Cr—Ta-based alloy, a Co—Cr—Pt-based alloy, a Co—Cr—Pt—Ta-based alloy, a Co—Cr—Pt—B—Ta-based alloy, a Co—Cr—Pt—B—Cu-based alloy, and a Co—Cr—Pt—B—Ag-based alloy.

For example, when a Co—Cr—Pt-based alloy is employed, preferably, the Cr content falls within a range of 10 at % to 27 at %, and the Pt content falls within a range of 8 at % to 16 at %, from the viewpoint of improvement of SNR. When a Co—Cr—Pt—B-based alloy is employed, preferably, the Cr content falls within a range of 10 at % to 27 at %, the Pt content falls within a range of 8 at % to 16 at %, and the B content falls within a range of 1 at % to 20 at %, from the viewpoint of improvement of SNR. When a Co—Cr—Pt—B—Ta-based alloy is employed, preferably, the Cr content falls within a range of 10 at % to 27 at %, the Pt content falls within a range of 8 at % to 16 at %, the B content falls within a range of 1 at % to 20 at %, and the Ta content falls within a range of 1 at % to 4 at %, from the viewpoint of improvement of SNR. When a Co—Cr—Pt—B—Cu-based alloy is employed, preferably, the Cr content falls within a range of 10 at % to 27 at %, the Pt content falls within a range of 8 at % to 16 at %, the B content falls within a range of 2 at % to 20 at %, and the Cu content falls within a range of 1 at % to 10 at %, from the viewpoint of improvement of SNR. When a Co—Cr—Pt—B—Ag-based alloy is employed, preferably, the Cr content falls within a range of 10 at % to 27 at %, the Pt content falls within a range of 8 at % to 16 at %, the B content falls within a range of 2 at % to 20 at %, and the Cu content falls within a range of 1 at % to 10 at %, from the viewpoint of improvement of SNR.

So long as the thickness of the magnetic layer 4 is 10 nm or more, no problem arises in terms of thermal decay. However, in order to meet the demand for high recording density, the thickness of the magnetic layer is preferably regulated to 40 nm or less. This is because, when the thickness exceeds 40 nm, crystal grains in the magnetic layer 4 become large in size, and preferred recording and reproduction characteristics fail to be obtained. The magnetic layer 4 may have a multi-layer structure, and each of the layers may be formed of any combination of materials selected from among the aforementioned materials. When the magnetic layer 4 has a multi-layer structure, a layer of the magnetic layer that is provided directly atop the non-magnetic intermediate layer 3 is preferably formed of a Co—Cr—Pt—B—Ta-based alloy, a Co—Cr—Pt—B—Cu-based alloy, or a Co—Cr—Pt—B-based alloy, from the viewpoint of improvement of SNR characteristics among recording and reproduction characteristics. The uppermost layer of the magnetic layer is preferably formed of a Co—Cr—Pt—B—Cu-based alloy or a Co—Cr—Pt—B-based alloy, from the viewpoint of improvement of SNR characteristics among recording and reproduction characteristics.

In the present invention, preferably, the stabilization layer 7 contains one or more species selected from among a CoCrZr-based alloy, a CoCrTa-based alloy, a CoRu-based alloy, a CoCrRu-based alloy, a CoCrPtZr-based alloy, a CoCrPtTa-based alloy, a CoPtRu-based alloy, and a CoCrPtRu-based alloy. The thickness of the stabilization layer 7 preferably falls within a range of 10 Å to 50 Å. When the thickness of the stabilization layer 7 is less than 10 Å, the stabilization layer 7 fails to be magnetized, and the stabilization layer 7 fails to be antiferromagnetically coupled with the magnetic layer 4, the layers 7 and 4 sandwiching the non-magnetic coupling layer 8. In contrast, when the thickness of the stabilization layer 7 exceeds 50 Å, crystal grains become large, leading to an increase in noise.

In the present invention, preferably, the non-magnetic coupling layer 8 contains any one species selected from among Ru, Rh, Ir, Cr, Re, an Ru-based alloy, an Rh-based alloy, an Ir-based alloy, a Cr-based alloy, and an Re-based alloy. Particularly preferably, Ru is employed. The thickness of the non-magnetic coupling layer 8 is preferably 0.5 to 1.5 nm, more preferably 0.8 nm or thereabouts. Particularly when the non-magnetic coupling layer 8 is formed of Ru, preferably, the layer thickness is regulated to 0.8 nm or thereabouts. This is because, when the Ru layer has such a thickness, the antiferromagnetic coupling intensity becomes a local maximum.

The protective layer 5 may be formed of a conventionally known material; for example, a single-component material such as carbon or SiC, or a material predominantly containing such a component. The thickness of the protective layer 5 preferably falls within a range of 1 nm to 10 nm, from the viewpoint of magnetic spacing reduction or durability when employed at high recording density. The term “magnetic spacing” refers to the distance between a read/write element of a magnetic head and the magnetic layer 4. The smaller the magnetic spacing, the more improved read-write conversion characteristics. The protective layer 5, which is present between the read-write element of the head and the magnetic layer 4, plays a role for increasing the magnetic spacing. If desired, the lubrication layer 6 formed of a fluorine-containing lubricant (e.g., perfluoropolyether) may be provided on the protective layer.

The magnetic layer 4 of the magnetic recording medium of the present invention preferably has a magnetic anisotropy index (OR) of 1.05 or more (more preferably 1.1 or more). The magnetic anisotropy index is represented by (coercive force in a tangential direction/coercive force in a radial direction). When the magnetic anisotropy index is 1.05 or more, magnetic characteristics (e.g., coercive force) and read-write conversion characteristics (e.g., SNR and PW50) are further enhanced. When the coercive force of the magnetic recording medium is increased to a high level, in some cases, the magnetic anisotropy index—which is defined by the ratio of coercive force (Hc) in a tangential direction to Hc in a radial direction is measured to be lower than the actual value.

In the present invention, in order to correct such an error, the magnetic anisotropy index of residual magnetization is employed in combination. The magnetic anisotropy index of residual magnetization (MrtOR) is defined by the ratio of residual magnetization (Mrt) in a tangential direction to residual magnetization (Mrt) in a radial direction (i.e., MrtOR=Mrt in a tangential direction/Mrt in a radial direction). When the magnetic anisotropy index of residual magnetization is 1.05 or more, preferably 1.1 or more, magnetic characteristics (e.g., coercive force) and read-write conversion characteristics (e.g., SNR and PW50) are further enhanced. When all the magnetic domains in the magnetic layer are oriented in a tangential direction (which is the ideal case), the denominator of the formula for calculating the magnetic anisotropy index becomes zero, and thus OR or MrtOR becomes infinity. The magnetic anisotropy index (OR) or the magnetic anisotropy index of residual magnetization (MrtOR) is measured by use of a vibrating sample magnetometer (VSM).

Next will be described a process for producing the magnetic recording medium of the present invention. A non-magnetic substrate 1 may be formed of any of the materials described above in (11) and (12). Now will be described production of the magnetic recording medium by taking, as an example, the case where the non-magnetic substrate 1 is an Al substrate on which an NiP film (12 μm) is formed through plating (hereinafter the substrate may be referred to as an “NiP-plated Al substrate”).

Firstly, the surface of the NiP-plated Al substrate is subjected to texturing, so as to form, on the surface thereof, grooves having a line density of 7,500 (lines/mm) or more. For example, in order to form, on the surface of the glass substrate, texture grooves having a line density of 7,500 (lines/mm) or more, the substrate surface is subjected to mechanical texturing in a tangential direction of the substrate by use of fixed abrasive grains and/or free abrasive grains. For example, texturing is carried out through the following procedure: a polishing tape is pressed onto the substrate surface to thereby bring the tape into contact with the surface, a polishing slurry containing abrasive grains is supplied between the tape and the substrate, and the polishing tape is moved in a tape-winding direction while the substrate is rotated.

In this case, the substrate may be rotated at 200 rpm to 1,000 rpm. The polishing slurry may be supplied at a rate of 10 mL/minute to 100 mL/minute. The polishing tape may be moved at a rate of 1.5 mm/minute to 150 mm/minute. The size of abrasive grains contained in the polishing slurry may be 0.05 μm to 0.3 μm at D90 (i.e., cumulative mass % is 90 mass %). The polishing tape may be pressed onto the substrate at a force of 1 kgf to 15 kgf (9.8 N to 147 N (relative pressure)). These conditions are appropriately determined so as to form texture grooves having a line density of preferably 7,500 (lines/mm) or more, more preferably 20,000 (lines/mm) or more. The average surface roughness (Ra) of the NiP-plated Al substrate having texture grooves on its surface preferably falls within a range of 0.1 nm to 1 nm (1 Å to 10 Å), more preferably 0.2 nm to 0.8 nm (2 Å to 8 Å).

The substrate may be subjected to texturing including oscillation. The term “oscillation” refers to a process in which a tape is caused to travel in a tangential direction of the substrate while the tape is reciprocated in a radial direction of the substrate. Preferably, oscillation is performed at a rate of 60 times/minute to 1,200 times/minute. Texturing may be carried out through a method for forming texture grooves having a line density of 7,500 (lines/mm) or more. In addition to the above-described mechanical texturing method, a method employing fixed abrasive grains, a method employing a fixed grinding wheel, or a method employing laser abrasion may be carried out. The line density of texture grooves may be determined by means of, for example, an AFM (atomic force microscope, product of Digital Instrument (US)).

The line density is measured under the following conditions: scan width: 1 μm, scan rate: 1 Hz, measurements: 256 times, mode: tapping mode. A probe is radially moved for scanning the glass substrate serving as a sample, to thereby yield an AFM image. The thus-obtained scan image is subjected to plane-fit auto-processing, which is a type of flattening processing, at a flatten order of 2 with respect to the X-axis and Y-axis of the scan image, to thereby flatten the image. The line density is calculated within a box area (about 0.5 μm×about 0.5 μm) on the flattened image. Specifically, the line density is calculated by converting the total number of “zero-level” crossings along the X-axis centerline and the Y-axis centerline to the corresponding number per mm. In other words, the line density indicates the number of peaks and valleys of the texture grooves per mm in a radial direction.

Line densities are measured in different areas on the surface of the sample, and the average value and standard deviation of the measured densities are obtained. The average value is regarded as the line density of the grooves of the glass substrate. The number of areas in which the line density is to be measured may be selected so as to obtain the average value and the standard deviation. For example, the number may be 10. When the average and the standard deviation are obtained at 8 of the 10 points after excluding the area in which the line density is maximum and the area in which the line density is minimum, abnormal measurement data can be eliminated, thereby enhancing measurement accuracy.

The NiP-plated Al substrate is washed, and then placed in a chamber of a film formation apparatus. If desired, the NiP-plated Al substrate is heated to 100° C. to 400° C. On the non-magnetic substrate, a non-magnetic base layer 2, a non-magnetic intermediate layer 3, and a magnetic layer 4 are formed through sputtering (e.g., DC or RF magnetron sputtering). Formation of the aforementioned layers through sputtering may be carried out under, for example, the following operation conditions.

For example, sputtering conditions for formation of the respective layers on the NiP-plated Al substrate are determined as described below. The chamber employed for forming the layers is evacuated so as to attain a vacuum of 10⁻⁴ Pa to 10⁻⁷ Pa. The glass substrate having texture grooves on its surface is placed in the chamber, and Ar gas serving as a sputtering gas is brought into the chamber, followed by discharging, to thereby form the layers through sputtering. During the course of sputtering, power to be applied is regulated to 0.2 kW to 2.0 kW. When the discharging time and the power to be applied are regulated, the layers having desired thicknesses can be formed.

Next will be described an example of a process for forming the magnetic recording medium. On a non-magnetic substrate, a non-magnetic base layer (thickness: 3 to 15 nm) is formed by use of a sputtering target containing, for example, a WX-based alloy, an MoX-based alloy (X═Zr, Nb, Hf, or Ta), Cr, or a Cr-based alloy.

Subsequently, a non-magnetic intermediate layer 3 (thickness: 1 to 10 nm) is formed by use of a sputtering target containing Ru or an RuY-based alloy (Y═Ti, Nb, Mo, Rh, Ta, W, Re, Ir, or Pt). Subsequently, a magnetic layer 4 (thickness: 10 to 40 nm) is formed by use of a sputtering target containing, for example, a CoCrTa-based alloy, a CoCrPt-based alloy, a CoCrPtTa-based alloy, a CoCrPtB-based alloy, a CoCrPtBTa-based alloy, a CoCrPtBCu-based alloy, or a CoRuTa-based alloy. Subsequently, a protective layer 5 (thickness: 1 to 5 nm) is formed through conventionally known sputtering or plasma CVD. Subsequently, if desired, a lubrication layer 6 is formed through conventionally known spin coating or dipping.

The aforementioned magnetic recording medium includes the non-magnetic base layer 2 formed of a WX-based alloy or an MoX-based alloy (X═Zr, Nb, Hf, or Ta), and the non-magnetic intermediate layer 3 formed of Ru or an RuY-based alloy (Y═Ti, Nb, Mo, Rh, Ta, W, Re, Ir, or Pt). Therefore, medium noise can be reduced.

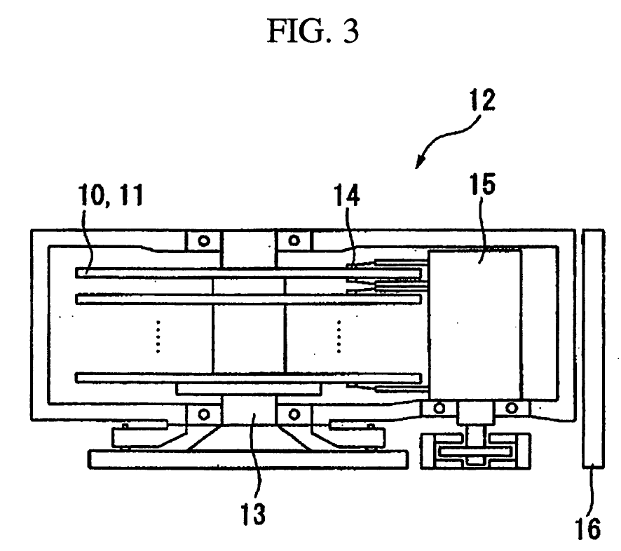

FIG. 3 shows an embodiment of the magnetic recording and reproducing apparatus incorporating the aforementioned magnetic recording medium.

The magnetic recording and reproducing apparatus 12 shown in FIG. 3 includes a magnetic recording medium 10 having the structure shown in FIG. 1 or a magnetic recording medium 11 having the structure shown in FIG. 2; a medium-driving section 13 which rotates the medium 10 or 11; a magnetic head 14 which is employed for recording of data onto the medium 10 or 11 and for reproduction of the data therefrom; a head-driving section 15 which drives the magnetic head 14 relative to the medium 10 or 11; and a recorded/reproduced-signal-processing system 16. In the recorded/reproduced-signal-processing system 16, input data are processed and recording signals are sent to the magnetic head 14, or reproduction signals from the head 14 are processed and the resultant data are output to the outside.

The magnetic recording and reproducing apparatus 12 of the present invention may employ, as the magnetic head 14, a magnetic head suitable for higher recording density containing a reproduction element, such as a magnetoresistance (MR) element utilizing giant magnetoresistive effect (GMR) or a GMR element utilizing tunnel magnetoresistive effect (TMR). Employment of a TMR element can further increase recording density.

The magnetic recording and reproducing apparatus 12 of the present invention includes the magnetic recording medium 10 or 11, the medium including the non-magnetic base layer 2 formed of a WX-based alloy or an MoX-based alloy (X═Zr, Nb, Hf, or Ta), and the non-magnetic intermediate layer 3 formed of Ru or an RuY-based alloy (Y═Ti, Nb, Mo, Rh, Ta, W, Re, Ir, or Pt). Therefore, medium noise can be reduced. The present invention attains production of a magnetic recording and reproducing apparatus suitable for high-density recording.

Operation and effects of the present invention will next be described in detail with reference to specific examples.

### TEST EXAMPLE 1

A magnetic recording medium 10 was produced by use of alloy layers having compositions and thicknesses shown in Table 1, the layers serving as a non-magnetic base layer 2 and a non-magnetic intermediate layer 3.

TABLE 1

| | Non-magnetic base layer | | | | | | | | | | | | | |
|---|---|---|---|---|---|---|---|---|---|---|---|---|---|---|
| | First component | | Second component | | Non-magnetic | | | | | | | | | |
| | layer | | layer | | intermediate layer | | Coer- | | | | | | | |
| | | Thick- | | Thick- | | Thick- | cive | Square- | | | | | | |
| Test | Alloy | ness | Alloy | ness | Alloy | ness | force | ness | | | TAA | OW | PW50 | SNR |
| Ex. | composition | nm | composition | nm | composition | nm | Oe | ratio | OR | MrtOR | (μV) | (dB) | (ns) | (dB) |
| 1 | Cr | 2 | 80W—20Zr | 4 | 50Ru—50Re | 4 | 4343 | 0.83 | 1.12 | 1.69 | 1362 | 39.2 | 8.05 | 19.8 |
| 2 | Cr | 2 | 80W—20Zr | 2 | 50Ru—50Re | 4 | 4215 | 0.82 | 1.11 | 1.66 | 1338 | 39.3 | 8.07 | 20.1 |
| 3 | Cr | 2 | 80W—20Zr | 6 | 50Ru—50Re | 4 | 4412 | 0.84 | 1.13 | 1.65 | 1383 | 38.2 | 8.06 | 19.7 |
| 4 | Cr | 2 | 80W—20Zr | 4 | 50Ru—50Re | 2 | 4218 | 0.83 | 1.13 | 1.69 | 1361 | 39.3 | 8.05 | 19.9 |
| 5 | Cr | 2 | 80W—20Zr | 4 | 50Ru—50Re | 6 | 4435 | 0.84 | 1.12 | 1.68 | 1364 | 38.4 | 8.06 | 20.2 |
| 6 | Cr | 2 | 95W—5Zr | 4 | 50Ru—50Re | 4 | 4372 | 0.83 | 1.12 | 1.65 | 1378 | 39.4 | 8.07 | 19.8 |
| 7 | Cr | 2 | 90W—10Zr | 4 | 50Ru—50Re | 4 | 4340 | 0.84 | 1.13 | 1.61 | 1345 | 39.3 | 8.02 | 19.9 |
| 8 | Cr | 2 | 70W—30Zr | 4 | 50Ru—50Re | 4 | 4363 | 0.81 | 1.12 | 1.66 | 1396 | 39.7 | 8.03 | 19.7 |
| 9 | Cr | 2 | 60W—40Zr | 4 | 50Ru—50Re | 4 | 4397 | 0.81 | 1.12 | 1.61 | 1374 | 39.1 | 8.05 | 20.0 |
| 10 | Cr | 2 | 80W—20Zr | 4 | 70Ru—30Re | 4 | 4337 | 0.82 | 1.12 | 1.66 | 1347 | 39.1 | 8.06 | 19.8 |
| 11 | Cr | 2 | 80W—20Zr | 4 | 30Ru—70Re | 4 | 4396 | 0.82 | 1.12 | 1.65 | 1389 | 39.5 | 8.04 | 20.3 |
| 12 | Cr | 2 | 75W—20Zr—5B | 4 | 50Ru—50Re | 4 | 4311 | 0.81 | 1.13 | 1.64 | 1376 | 40.1 | 8.04 | 20.6 |
| 13 | Cr | 2 | 80W—20Zr | 4 | Ru | 4 | 4308 | 0.82 | 1.13 | 1.60 | 1332 | 39.9 | 8.11 | 19.8 |
| 14 | Cr | 2 | 80W—20Zr | 4 | 50Ru—50Rh | 4 | 4308 | 0.82 | 1.13 | 1.60 | 1332 | 39.9 | 8.10 | 19.7 |
| 15 | Cr | 2 | 80W—20Zr | 4 | 50Ru—50Ir | 4 | 4337 | 0.83 | 1.14 | 1.69 | 1342 | 39.2 | 8.05 | 19.8 |
| 16 | Cr | 2 | 80W—20Zr | 4 | 80Ru—20Ti | 4 | 4338 | 0.84 | 1.13 | 1.60 | 1354 | 39.2 | 8.07 | 19.7 |
| 17 | Cr | 2 | 80W—20Zr | 4 | 80Ru—20Nb | 4 | 4349 | 0.82 | 1.12 | 1.63 | 1334 | 39.9 | 8.11 | 19.6 |
| 18 | Cr | 2 | 80W—20Zr | 4 | 80Ru—20Mo | 4 | 4400 | 0.84 | 1.14 | 1.65 | 1373 | 40.0 | 8.04 | 19.5 |
| 19 | Cr | 2 | 80W—20Zr | 4 | 80Ru—20W | 4 | 4327 | 0.82 | 1.12 | 1.65 | 1360 | 39.1 | 8.10 | 19.8 |
| 20 | Cr | 2 | 80W—20Zr | 4 | 80Ru—20Pt | 4 | 4311 | 0.83 | 1.13 | 1.68 | 1348 | 39.9 | 8.07 | 19.8 |

Specifically, an NiP film (thickness: 12 μm) was formed through electroless plating on the surface of an Al substrate base (outer diameter: 95 mm, inner diameter: 25 mm, thickness: 1.270 mm), and the surface of the film was subjected to texturing so as to attain an average surface roughness (Ra) of 0.5 nm. The resultant product was employed as a non-magnetic substrate 1. The non-magnetic substrate 1 was placed in a DC magnetron sputtering apparatus (model: C3010, product of ANELVA). Subsequently, the chamber was evacuated so as to attain a vacuum of 2×10⁻⁷ Torr (2.7×10⁻⁵ Pa), and then the non-magnetic substrate 1 was heated to 250° C. A non-magnetic base layer 2 was provided on the substrate. The non-magnetic base layer 2 was formed so as to have a multi-layer structure including a first component layer (thickness: 2 nm) formed of Cr, and a second component layer (thickness: 3 nm) formed of a WZr alloy (W: 80 at %, Zr: 20 at %) and provided on the first component layer.

Subsequently, a non-magnetic intermediate layer 3 (thickness: 4 nm) was formed from an RuRe alloy (Ru: 50 at %, Re: 50 at %).

Subsequently, a magnetic layer 4 was provided. Specifically, a first component layer (thickness: 10 nm) was formed from a CoCrPtB alloy (Co: 60 at %, Cr: 25 at %, Pt: 14 at %, B: 6 at %), and directly thereon, a second component layer (thickness: 10 nm) was formed from a CoCrPtB alloy (Co: 60 at %, Cr: 10 at %, Pt: 15 at %, B: 15 at %).

During the course of formation of the aforementioned layers, Ar was employed as a sputtering gas, and the gas pressure was regulated to 6 mTorr (0.8 Pa). Subsequently, a carbon protective layer 5 (thickness: 3 nm) was formed through CVD. Subsequently, a lubricant containing perfluoropolyether was applied onto the surface of the protective layer 5, to thereby form a lubrication layer 6 (thickness: 2 nm). Thus, a magnetic recording medium 10 was produced.

Thereafter, glide test was performed at a glide height of 0.4μ inch by use of a glide tester, and recording and reproduction characteristics of the magnetic recording medium 10 which had passed the glide test were evaluated by use of read/write analyzer RWA1632 (product of GUZIK (US)). In order to evaluate recording and reproduction characteristics, read-write conversion characteristics, including reproduction signal output (TAA), half power width of isolated read pulse (PW50), SNR, and overwrite (OW) were measured. Recording and reproduction characteristics were evaluated by use of a complex-type thin-film magnetic recording head having a giant magnetoresistive (GMR) element at the reproduction section.

Recording of pattern signals was performed at 500 kFCI, and integral noise was measured at a frequency falling within a range of 1 MHz to a frequency corresponding to 375 kFCI. Reproduction output was measured at 250 kFCI, and SNR was calculated by use of the following equation: SNR=20×log(reproduction output/integral noise as measured at a frequency falling within a range of 1 MHz to a frequency corresponding to 375 kFCI). Coercive force (Hc) and squareness ratio (S*) were measured by use of a Kerr-effect-type magnetic characteristic measuring apparatus (model: RO1900, product of Hitachi Electronics Engineering Co., Ltd. (Japan)). Magnetic anisotropy index (OR) and magnetic anisotropy index of residual magnetization (MrtOR) were measured by use of a VSM (model: BHV-35, product of Riken Denshi Co., Ltd. (Japan)).

### TEST EXAMPLES 2 THROUGH 83

The procedure of Test Example 1 was repeated, except that the WZr alloy layer having the aforementioned composition and thickness, which serves as the second component layer of the non-magnetic base layer 2, was replaced by an alloy layer having a composition and thickness shown in Tables 1 through 4, and that the RuRe alloy layer having the aforementioned composition and thickness, which serves as the non-magnetic intermediate layer 3, was replaced by an alloy layer having a composition and thickness shown in Table 1, to thereby produce a magnetic recording medium 10. In the Tables, 1 Oe corresponds to about 79 A/m.

TABLE 2

| | Non-magnetic base layer | | | | | | | | | | | | | |
|---|---|---|---|---|---|---|---|---|---|---|---|---|---|---|
| | First component | | Second component | | Non-magnetic | | | | | | | | | |
| | layer | | layer | | intermediate layer | | | | | | | | | |
| | | Thick- | | Thick- | | Thick- | Coercive | Square- | | | | | | |
| Test | Alloy | ness | Alloy | ness | Alloy | ness | force | ness | | | TAA | OW | PW50 | SNR |
| Ex. | composition | nm | composition | nm | composition | nm | Oe | ratio | OR | MrtOR | (μV) | (dB) | (ns) | (dB) |
| 21 | Cr | 2 | 80W—20Nb | 4 | 50Ru—50Re | 4 | 4311 | 0.82 | 1.12 | 1.63 | 1340 | 40.0 | 8.05 | 20.1 |
| 22 | Cr | 2 | 80W—20Nb | 4 | Ru | 4 | 4382 | 0.84 | 1.13 | 1.70 | 1335 | 39.4 | 8.08 | 19.7 |
| 23 | Cr | 2 | 80W—20Nb | 4 | 50Ru—50Rh | 4 | 4345 | 0.83 | 1.12 | 1.64 | 1349 | 39.1 | 8.10 | 20.2 |
| 24 | Cr | 2 | 80W—20Nb | 4 | 50Ru—50Ir | 4 | 4394 | 0.85 | 1.14 | 1.64 | 1370 | 39.7 | 8.08 | 20.2 |
| 25 | Cr | 2 | 80W—20Nb | 4 | 80Ru—20Ti | 4 | 4394 | 0.85 | 1.14 | 1.64 | 1370 | 39.7 | 8.08 | 20.2 |
| 26 | Cr | 2 | 80W—20Nb | 4 | 80Ru—20Nb | 4 | 4387 | 0.81 | 1.13 | 1.63 | 1387 | 39.1 | 8.09 | 20.2 |
| 27 | Cr | 2 | 80W—20Nb | 4 | 80Ru—20Mo | 4 | 4387 | 0.83 | 1.13 | 1.70 | 1337 | 39.6 | 8.04 | 19.8 |
| 28 | Cr | 2 | 80W—20Nb | 4 | 80Ru—20W | 4 | 4363 | 0.82 | 1.11 | 1.64 | 1388 | 39.7 | 8.11 | 20.1 |
| 29 | Cr | 2 | 80W—20Nb | 4 | 80Ru—20Pt | 4 | 4307 | 0.83 | 1.12 | 1.62 | 1339 | 39.3 | 8.10 | 20.0 |
| 30 | Cr | 2 | 80W—20Hf | 4 | 50Ru—50Re | 4 | 4318 | 0.82 | 1.13 | 1.68 | 1356 | 39.3 | 8.11 | 20.0 |
| 31 | Cr | 2 | 80W—20Hf | 4 | Ru | 4 | 4368 | 0.81 | 1.12 | 1.67 | 1340 | 39.9 | 8.07 | 20.0 |
| 32 | Cr | 2 | 80W—20Hf | 4 | 50Ru—50Rh | 4 | 4344 | 0.84 | 1.10 | 1.68 | 1359 | 39.8 | 8.12 | 20.3 |
| 33 | Cr | 2 | 80W—20Hf | 4 | 50Ru—50Ir | 4 | 4324 | 0.83 | 1.10 | 1.62 | 1336 | 39.8 | 8.09 | 20.0 |
| 34 | Cr | 2 | 80W—20Hf | 4 | 80Ru—20Ti | 4 | 4324 | 0.83 | 1.10 | 1.62 | 1336 | 39.8 | 8.09 | 20.0 |
| 35 | Cr | 2 | 80W—20Hf | 4 | 80Ru—20Nb | 4 | 4342 | 0.84 | 1.13 | 1.61 | 1397 | 39.9 | 8.07 | 20.3 |
| 36 | Cr | 2 | 80W—20Hf | 4 | 80Ru—20Mo | 4 | 4337 | 0.81 | 1.12 | 1.63 | 1339 | 39.6 | 8.03 | 20.3 |
| 37 | Cr | 2 | 80W—20Hf | 4 | 80Ru—20W | 4 | 4307 | 0.85 | 1.10 | 1.65 | 1349 | 39.1 | 8.09 | 19.8 |
| 38 | Cr | 2 | 80W—20Hf | 4 | 80Ru—20Pt | 4 | 4328 | 0.82 | 1.10 | 1.68 | 1357 | 39.7 | 8.11 | 20.2 |
| 39 | Cr | 2 | 80W—20Ta | 4 | 50Ru—50Re | 4 | 4347 | 0.84 | 1.13 | 1.63 | 1376 | 39.0 | 8.08 | 20.3 |
| 40 | Cr | 2 | 80W—20Ta | 4 | Ru | 4 | 4372 | 0.82 | 1.11 | 1.63 | 1364 | 39.5 | 8.12 | 20.4 |

TABLE 3

| | Non-magnetic base layer | | | | | | | | | | | | | |
|---|---|---|---|---|---|---|---|---|---|---|---|---|---|---|
| | First component | | Second component | | Non-magnetic | | | | | | | | | |
| | layer | | layer | | intermediate layer | | Coer- | | | | | | | |
| | | Thick- | | Thick- | | Thick- | cive | Square- | | | | | | |
| Test | Alloy | ness | Alloy | ness | Alloy | ness | force | ness | | | TAA | OW | PW50 | SNR |
| Ex. | composition | nm | composition | nm | composition | nm | Oe | ratio | OR | MrtOR | (μV) | (dB) | (ns) | (dB) |
| 41 | Cr | 2 | 80W—20Ta | 4 | 50Ru—50Re | 4 | 4319 | 0.84 | 1.13 | 1.63 | 1380 | 39.0 | 8.12 | 19.8 |
| 42 | Cr | 2 | 80W—20Ta | 4 | 50Ru—50Ir | 4 | 4306 | 0.82 | 1.12 | 1.70 | 1365 | 39.4 | 8.09 | 19.9 |
| 43 | Cr | 2 | 80W—20Ta | 4 | 80Ru—20Ti | 4 | 4306 | 0.82 | 1.12 | 1.70 | 1365 | 39.4 | 8.09 | 19.9 |
| 44 | Cr | 2 | 80W—20Ta | 4 | 80Ru—20Nb | 4 | 4361 | 0.82 | 1.12 | 1.63 | 1363 | 39.5 | 8.13 | 20.1 |
| 45 | Cr | 2 | 80W—20Ta | 4 | 80Ru—20Mo | 4 | 4363 | 0.85 | 1.12 | 1.64 | 1396 | 39.1 | 8.01 | 20.0 |
| 46 | Cr | 2 | 80W—20Ta | 4 | 80Ru—20W | 4 | 4347 | 0.85 | 1.10 | 1.61 | 1388 | 39.8 | 8.07 | 19.9 |
| 47 | Cr | 2 | 80W—20Ta | 4 | 80Ru—20Pt | 4 | 4390 | 0.85 | 1.14 | 1.63 | 1340 | 39.5 | 8.07 | 19.8 |
| 48 | Cr | 2 | 80Mo—20Zr | 4 | 50Ru—50Re | 4 | 4314 | 0.85 | 1.12 | 1.62 | 1349 | 39.1 | 8.01 | 20.8 |
| 49 | Cr | 2 | 80Mo—20Zr | 4 | Ru | 4 | 4367 | 0.81 | 1.12 | 1.67 | 1358 | 39.8 | 8.12 | 20.0 |
| 50 | Cr | 2 | 80Mo—20Zr | 4 | 50Ru—50Rh | 4 | 4369 | 0.83 | 1.13 | 1.67 | 1354 | 39.7 | 8.10 | 19.7 |
| 51 | Cr | 2 | 80Mo—20Zr | 4 | 50Ru—50Ir | 4 | 4345 | 0.84 | 1.13 | 1.60 | 1383 | 39.5 | 8.13 | 19.8 |
| 52 | Cr | 2 | 80Mo—20Zr | 4 | 80Ru—20Ti | 4 | 4345 | 0.83 | 1.13 | 1.60 | 1383 | 39.5 | 8.13 | 19.8 |
| 53 | Cr | 2 | 80Mo—20Zr | 4 | 80Ru—20Nb | 4 | 4316 | 0.84 | 1.13 | 1.67 | 1386 | 39.4 | 8.10 | 20.2 |
| 54 | Cr | 2 | 80Mo—20Zr | 4 | 80Ru—20Mo | 4 | 4350 | 0.82 | 1.13 | 1.69 | 1358 | 39.9 | 8.02 | 20.1 |
| 55 | Cr | 2 | 80Mo—20Zr | 4 | 80Ru—20W | 4 | 4346 | 0.83 | 1.14 | 1.68 | 1392 | 39.7 | 8.04 | 19.9 |
| 56 | Cr | 2 | 80Mo—20Zr | 4 | 80Ru—20Pt | 4 | 4389 | 0.82 | 1.11 | 1.68 | 1340 | 39.2 | 8.15 | 20.0 |
| 57 | Cr | 2 | 80Mo—20Nb | 4 | 50Ru—50Re | 4 | 4349 | 0.81 | 1.12 | 1.68 | 1337 | 40.0 | 8.03 | 20.0 |
| 58 | Cr | 2 | 80Mo—20Nb | 4 | Ru | 4 | 4333 | 0.85 | 1.13 | 1.63 | 1359 | 39.2 | 8.04 | 20.2 |
| 59 | Cr | 2 | 80Mo—20Nb | 4 | 50Ru—50Rh | 4 | 4314 | 0.85 | 1.13 | 1.64 | 1383 | 39.7 | 8.06 | 20.4 |
| 60 | Cr | 2 | 80Mo—20Nb | 4 | 50Ru—50Ir | 4 | 4363 | 0.84 | 1.14 | 1.68 | 1389 | 39.1 | 8.05 | 20.1 |

TABLE 4

| | Non-magnetic base layer | | | | | | | | | | | | | |
|---|---|---|---|---|---|---|---|---|---|---|---|---|---|---|
| | First component | | Second component | | Non-magnetic | | | | | | | | | |
| | layer | | layer | | intermediate layer | | Coer- | | | | | | | |
| | | Thick- | | Thick- | | Thick- | cive | Square- | | | | | | |
| Test | Alloy | ness | Alloy | ness | Alloy | ness | force | ness | | | TAA | OW | PW50 | SNR |
| Ex. | composition | nm | composition | nm | composition | nm | Oe | ratio | OR | MrtOR | (μV) | (dB) | (ns) | (dB) |
| 61 | Cr | 2 | 80Mo—20Nb | 4 | 80Ru—20Ti | 4 | 4363 | 0.83 | 1.14 | 1.68 | 1389 | 39.1 | 8.05 | 20.1 |
| 62 | Cr | 2 | 80Mo—20Nb | 4 | 80Ru—20Nb | 4 | 4350 | 0.81 | 1.12 | 1.66 | 1353 | 39.3 | 8.07 | 20.0 |
| 63 | Cr | 2 | 80Mo—20Nb | 4 | 80Ru—20Mo | 4 | 4325 | 0.82 | 1.12 | 1.62 | 1341 | 39.7 | 8.11 | 20.3 |
| 64 | Cr | 2 | 80Mo—20Nb | 4 | 80Ru—20W | 4 | 4372 | 0.85 | 1.10 | 1.63 | 1343 | 39.9 | 8.11 | 19.8 |
| 65 | Cr | 2 | 80Mo—20Nb | 4 | 80Ru—20Pt | 4 | 4339 | 0.84 | 1.14 | 1.67 | 1386 | 39.8 | 8.09 | 19.7 |
| 66 | Cr | 2 | 80Mo—20Hf | 4 | 50Ru—50Re | 4 | 4396 | 0.83 | 1.12 | 1.64 | 1343 | 39.3 | 8.10 | 20.1 |
| 67 | Cr | 2 | 80Mo—20Hf | 4 | Ru | 4 | 4367 | 0.84 | 1.11 | 1.69 | 1358 | 39.9 | 8.05 | 20.2 |
| 68 | Cr | 2 | 80Mo—20Hf | 4 | 50Ru—50Rh | 4 | 4365 | 0.82 | 1.14 | 1.62 | 1367 | 39.5 | 8.11 | 19.8 |
| 69 | Cr | 2 | 80Mo—20Hf | 4 | 50Ru—50Ir | 4 | 4356 | 0.85 | 1.13 | 1.62 | 1395 | 39.2 | 8.11 | 20.2 |
| 70 | Cr | 2 | 80Mo—20Hf | 4 | 80Ru—20Ti | 4 | 4356 | 0.85 | 1.13 | 1.62 | 1395 | 39.2 | 8.11 | 20.2 |
| 71 | Cr | 2 | 80Mo—20Hf | 4 | 80Ru—20Nb | 4 | 4309 | 0.82 | 1.12 | 1.62 | 1349 | 39.0 | 8.09 | 20.3 |
| 72 | Cr | 2 | 80Mo—20Hf | 4 | 80Ru—20Mo | 4 | 4314 | 0.83 | 1.12 | 1.67 | 1348 | 39.2 | 8.12 | 19.9 |
| 73 | Cr | 2 | 80Mo—20Hf | 4 | 80Ru—20W | 4 | 4350 | 0.85 | 1.11 | 1.63 | 1396 | 39.9 | 8.10 | 20.1 |
| 74 | Cr | 2 | 80Mo—20Hf | 4 | 80Ru—20Pt | 4 | 4315 | 0.83 | 1.12 | 1.69 | 1331 | 39.9 | 8.08 | 20.2 |
| 75 | Cr | 2 | 80Mo—20Ta | 4 | 50Ru—50Re | 4 | 4321 | 0.82 | 1.13 | 1.66 | 1336 | 39.1 | 8.14 | 20.4 |
| 76 | Cr | 2 | 80Mo—20Ta | 4 | Ru | 4 | 4348 | 0.82 | 1.10 | 1.60 | 1353 | 39.6 | 8.03 | 19.8 |
| 77 | Cr | 2 | 80Mo—20Ta | 4 | 50Ru—50Rh | 4 | 4327 | 0.83 | 1.11 | 1.64 | 1400 | 39.7 | 8.07 | 20.1 |
| 78 | Cr | 2 | 80Mo—20Ta | 4 | 50Ru—50Ir | 4 | 4358 | 0.85 | 1.10 | 1.69 | 1384 | 39.8 | 8.11 | 19.8 |
| 79 | Cr | 2 | 80Mo—20Ta | 4 | 80Ru—20Ti | 4 | 4358 | 0.85 | 1.10 | 1.69 | 1384 | 39.8 | 8.11 | 19.8 |
| 80 | Cr | 2 | 80Mo—20Ta | 4 | 80Ru—20Nb | 4 | 4349 | 0.83 | 1.13 | 1.69 | 1361 | 39.7 | 8.08 | 20.2 |
| 81 | Cr | 2 | 80Mo—20Ta | 4 | 80Ru—20Mo | 4 | 4368 | 0.84 | 1.11 | 1.63 | 1370 | 39.6 | 8.14 | 20.0 |
| 82 | Cr | 2 | 80Mo—20Ta | 4 | 80Ru—20W | 4 | 4338 | 0.83 | 1.12 | 1.69 | 1368 | 39.9 | 8.15 | 19.8 |
| 83 | Cr | 2 | 80Mo—20Ta | 4 | 80Ru—20Pt | 4 | 4380 | 0.84 | 1.12 | 1.68 | 1376 | 39.5 | 8.09 | 20.0 |

### TEST EXAMPLE 84

A magnetic recording medium 11 was produced by use of alloy layers having compositions and thicknesses shown in Table 5, the layers serving as a non-magnetic base layer 2, a non-magnetic intermediate layer 3, and a stabilization layer 7.

Specifically, an NiP film (thickness: 12 μm) was formed through electroless plating on the surface of an Al substrate base (outer diameter: 95 mm, inner diameter: 25 mm, thickness: 1.270 mm), and the surface of the film was subjected to texturing so as to attain an average surface roughness (Ra) of 0.5 nm. The resultant product was employed as a non-magnetic substrate 1. The non-magnetic substrate 1 was placed in a DC magnetron sputtering apparatus (model: C3010, product of ANELVA). Subsequently, the chamber was evacuated so as to attain a vacuum of 2×10⁻⁷ Torr (2.7×10⁻⁵ Pa), and then the non-magnetic substrate 1 was heated to 250° C. A non-magnetic base layer 2 was provided on the substrate. The non-magnetic base layer 2 was formed so as to have a multi-layer structure including a first component layer (thickness: 2 μm) formed of Cr, and a second component layer (thickness: 3 nm) formed of a WZr alloy (W: 80 at %, Zr: 20 at %) and provided on the first component layer.

TABLE 5

| | Non-magnetic base layer | | | | | | | |
|---|---|---|---|---|---|---|---|---|
| | First component | | Second component | | Non-magnetic | | | |
| | layer | | layer | | intermediate layer | | Stabilizing layer | |
| Test | Alloy | Thickness | Alloy | Thickness | Alloy | Thickness | Alloy | Thickness |
| Ex. | composition | nm | composition | nm | composition | nm | composition | nm |
| 84 | Cr | 2 | 80W—20Zr | 4 | 50Ru—50Re | 4 | 67Co—20Cr—10Pt—3Ta | 3 |
| 85 | Cr | 2 | 80W—20Zr | 4 | Ru | 4 | 67Co—20Cr—10Pt—3Ta | 3 |
| 86 | Cr | 2 | 80W—20Zr | 4 | 50Ru—50Rh | 4 | 67Co—20Cr—10Pt—3Ta | 3 |
| 87 | Cr | 2 | 80W—20Zr | 4 | 50Ru—50Ir | 4 | 67Co—20Cr—10Pt—3Ta | 3 |
| 88 | Cr | 2 | 80W—20Zr | 4 | 80Ru—20Ti | 4 | 67Co—20Cr—10Pt—3Ta | 3 |
| 89 | Cr | 2 | 80W—20Zr | 4 | 80Ru—20Nb | 4 | 67Co—20Cr—10Pt—3Ta | 3 |
| 90 | Cr | 2 | 80W—20Zr | 4 | 80Ru—20Mo | 4 | 67Co—20Cr—10Pt—3Ta | 3 |
| 91 | Cr | 2 | 80W—20Zr | 4 | 80Ru—20W | 4 | 67Co—20Cr—10Pt—3Ta | 3 |
| 92 | Cr | 2 | 80W—20Zr | 4 | 80Ru—20Pt | 4 | 67Co—20Cr—10Pt—3Ta | 3 |
| 93 | Cr | 2 | 75W—15Zr—5B | 4 | 50Ru—50Re | 4 | 67Co—20Cr—10Pt—3Ta | 3 |
| 94 | Cr | 2 | 80W—20Nb | 4 | 50Ru—50Re | 4 | 67Co—20Cr—10Pt—3Ta | 3 |
| 95 | Cr | 2 | 80W—20Hf | 4 | 50Ru—50Re | 4 | 67Co—20Cr—10Pt—3Ta | 3 |
| 96 | Cr | 2 | 80W—20Ta | 4 | 50Ru—50Re | 4 | 67Co—20Cr—10Pt—3Ta | 3 |
| 97 | Cr | 2 | 80Mo—20Zr | 4 | 50Ru—50Re | 4 | 67Co—20Cr—10Pt—3Ta | 3 |
| 98 | Cr | 2 | 80Mo—20Nb | 4 | 50Ru—50Re | 4 | 67Co—20Cr—10Pt—3Ta | 3 |
| 99 | Cr | 2 | 80Mo—20Hf | 4 | 50Ru—50Re | 4 | 67Co—20Cr—10Pt—3Ta | 3 |
| 100 | Cr | 2 | 80Mo—20Ta | 4 | 50Ru—50Re | 4 | 67Co—20Cr—10Pt—3Ta | 3 |

| | Coercive | | | | | | | |
|---|---|---|---|---|---|---|---|---|
| Test | force | Squareness | | | TAA | OW | PW50 | SNR |
| Ex. | Oe | ratio | OR | MrtOR | (μV) | (dB) | (ns) | (dB) |
| 84 | 4274 | 0.84 | 1.11 | 1.67 | 1232 | 40.2 | 7.92 | 20.2 |
| 85 | 4223 | 0.82 | 1.11 | 1.66 | 1281 | 40.6 | 7.98 | 20.6 |
| 86 | 4282 | 0.83 | 1.12 | 1.69 | 1266 | 40.5 | 7.96 | 20.2 |
| 87 | 4298 | 0.83 | 1.12 | 1.61 | 1280 | 40.7 | 7.97 | 20.4 |
| 88 | 4278 | 0.82 | 1.11 | 1.60 | 1270 | 40.3 | 7.94 | 20.4 |
| 89 | 4206 | 0.82 | 1.13 | 1.67 | 1247 | 40.4 | 8.03 | 20.3 |
| 90 | 4264 | 0.84 | 1.11 | 1.64 | 1243 | 40.9 | 8.02 | 20.5 |
| 91 | 4277 | 0.84 | 1.13 | 1.69 | 1287 | 40.2 | 8.02 | 20.3 |
| 92 | 4205 | 0.81 | 1.11 | 1.69 | 1248 | 40.9 | 8.05 | 20.1 |
| 93 | 4215 | 0.82 | 1.10 | 1.68 | 1256 | 40.5 | 7.91 | 20.5 |
| 94 | 4271 | 0.82 | 1.11 | 1.61 | 1259 | 40.4 | 7.90 | 20.6 |
| 95 | 4202 | 0.81 | 1.13 | 1.60 | 1283 | 40.6 | 8.01 | 20.5 |
| 96 | 4285 | 0.84 | 1.11 | 1.69 | 1240 | 40.2 | 7.96 | 20.4 |
| 97 | 4216 | 0.84 | 1.13 | 1.62 | 1289 | 40.5 | 8.02 | 20.7 |
| 98 | 4231 | 0.81 | 1.13 | 1.69 | 1270 | 40.2 | 8.02 | 20.5 |
| 99 | 4247 | 0.85 | 1.12 | 1.63 | 1282 | 40.3 | 7.94 | 20.5 |
| 100 | 4298 | 0.85 | 1.13 | 1.70 | 1286 | 40.0 | 7.99 | 20.3 |

Subsequently, a non-magnetic intermediate layer 3 was formed from an RuRe alloy (Ru: 50 at %, Re: 50 at %). Thereafter, a stabilization layer 7 (thickness: 3 nm) was formed from a CoCrPtTa alloy (Co: 67 at %, Cr: 20 at %, Pt: 10 at %, Ta: 3 at %). Subsequently, a non-magnetic coupling layer 8 (thickness: 0.8 μm) was formed from Ru.

Subsequently, a magnetic layer 4 was provided. Specifically, a first component layer (thickness: 10 μm) was formed from a CoCrPtB alloy (Co: 60 at %, Cr: 25 at %, Pt: 14 at %, B: 6 at %), and directly thereon, a second component layer (thickness: 10 nm) was formed from a CoCrPtB alloy (Co: 60 at %, Cr: 10 at %, Pt: 15 at %, B: 15 at %). During the course of formation of the aforementioned layers, Ar was employed as a sputtering gas, and the gas pressure was regulated to 6 mTorr (0.8 Pa). Subsequently, a carbon protective layer 5 (thickness: 3 nm) was formed through CVD. Subsequently, a lubricant containing perfluoropolyether was applied onto the surface of the protective layer 5, to thereby form a lubrication layer 6 (thickness: 2 nm). Thus, a magnetic recording medium 11 was produced.

### TEST EXAMPLES 85 THROUGH 100

The procedure of Test Example 84 was repeated, except that the WZr alloy layer having the aforementioned composition and thickness, which serves as the second component layer of the non-magnetic base layer 2, was replaced by an alloy layer having a composition shown in Table 5, to thereby produce a magnetic recording medium 11.

### TEST EXAMPLE 101

A magnetic recording medium 10 was produced by use of alloy layers having compositions and thicknesses shown in Table 6, the layers serving as a non-magnetic base layer 2 and a non-magnetic intermediate layer 3.

Specifically, a glass substrate (outer diameter: 65 mm, inner diameter: 20 mm, thickness: 0.635 mm) was subjected to texturing so as to attain an average surface roughness (Ra) of 0.3 nm. The resultant substrate was employed as a non-magnetic substrate 1. The non-magnetic substrate 1 was placed in a DC magnetron sputtering apparatus (model: C3010, product of ANELVA). Subsequently, the chamber was evacuated so as to attain a vacuum of 2×10⁻⁷ Torr (2.7×10⁻⁵ Pa), and then the non-magnetic substrate 1 was heated to 250° C. On the substrate, an alignment-regulating layer (thickness: 5 nm) was formed from a CoW alloy (Co: 50 at %, W: 50 at %), followed by heating to 250° C. Subsequently, the surface of the alignment-regulating layer was exposed to oxygen gas. The oxygen gas pressure was regulated to 0.05 Pa, and the exposure treatment was performed for five seconds. A non-magnetic base layer 2 was provided on the thus-treated substrate. The non-magnetic base layer 2 was formed so as to have a multi-layer structure including a first component layer (thickness: 2 nm) formed of Cr, and a second component layer (thickness: 3 nm) formed of a WZr alloy (W: 80 at %, Zr: 20 at %) and provided on the first component layer. Subsequently, a non-magnetic intermediate layer 3 (thickness: 4 nm) was formed from an RuRe alloy (Ru: 50 at %, Re: 50 at %).

TABLE 6

| | Non-magnetic base layer | | | | | | | | | | | | | |
|---|---|---|---|---|---|---|---|---|---|---|---|---|---|---|
| | First component | | Second component | | Non-magnetic | | | | | | | | | |
| | layer | | layer | | intermediate layer | | Coer- | | | | | | | |
| | | Thick- | | Thick- | | Thick- | cive | Square- | | | | | | |
| Test | Alloy | ness | Alloy | ness | Alloy | ness | force | ness | | | TAA | OW | PW50 | SNR |
| Ex. | composition | nm | composition | nm | composition | nm | Oe | ratio | OR | MrtOR | (μV) | (dB) | (ns) | (dB) |
| 101 | Cr | 2 | 80W—20Zr | 4 | 50Ru—50Re | 4 | 4211 | 0.84 | 1.11 | 1.53 | 1182 | 41.2 | 8.05 | 19.8 |
| 102 | Cr | 2 | 80W—20Zr | 4 | Ru | 4 | 4228 | 0.80 | 1.10 | 1.52 | 1236 | 41.0 | 8.00 | 20.3 |
| 103 | Cr | 2 | 80W—20Zr | 4 | 50Ru—50Rh | 4 | 4224 | 0.84 | 1.11 | 1.48 | 1241 | 41.1 | 8.03 | 20.2 |
| 104 | Cr | 2 | 80W—20Zr | 4 | 50Ru—50Ir | 4 | 4218 | 0.83 | 1.09 | 1.49 | 1227 | 41.1 | 8.14 | 20.3 |
| 105 | Cr | 2 | 80W—20Zr | 4 | 80Ru—20Ir | 4 | 4211 | 0.82 | 1.10 | 1.50 | 1254 | 40.5 | 8.13 | 20.4 |
| 106 | Cr | 2 | 80W—20Zr | 4 | 80Ru—20Nb | 4 | 4191 | 0.81 | 1.11 | 1.53 | 1181 | 41.9 | 8.10 | 20.4 |
| 107 | Cr | 2 | 80W—20Zr | 4 | 80Ru—20Mo | 4 | 4229 | 0.82 | 1.08 | 1.53 | 1220 | 41.2 | 8.02 | 20.0 |
| 108 | Cr | 2 | 80W—20Zr | 4 | 80Ru—20W | 4 | 4206 | 0.83 | 1.10 | 1.50 | 1230 | 41.4 | 8.11 | 20.1 |
| 109 | Cr | 2 | 80W—20Zr | 4 | 80Ru—20Pt | 4 | 4243 | 0.84 | 1.10 | 1.46 | 1204 | 41.8 | 8.02 | 19.9 |
| 110 | Cr | 2 | 75W—15Zr—5B | 4 | 50Ru—50Re | 4 | 4198 | 0.83 | 1.11 | 1.54 | 1212 | 40.4 | 8.05 | 20.5 |
| 111 | Cr | 2 | 80W—20Nb | 4 | 50Ru—50Re | 4 | 4211 | 0.80 | 1.08 | 1.52 | 1241 | 41.2 | 8.14 | 20.1 |
| 112 | Cr | 2 | 80W—20Hf | 4 | 50Ru—50Re | 4 | 4236 | 0.81 | 1.11 | 1.54 | 1180 | 41.7 | 8.00 | 20.3 |
| 113 | Cr | 2 | 80W—20Ta | 4 | 50Ru—50Re | 4 | 4237 | 0.82 | 1.10 | 1.54 | 1236 | 41.9 | 8.09 | 19.8 |
| 114 | Cr | 2 | 80Mo—20Zr | 4 | 50Ru—50Re | 4 | 4181 | 0.82 | 1.10 | 1.52 | 1194 | 41.0 | 8.01 | 20.3 |
| 115 | Cr | 2 | 80Mo—20Nb | 4 | 50Ru—50Re | 4 | 4162 | 0.81 | 1.10 | 1.50 | 1229 | 41.3 | 8.11 | 20.1 |
| 116 | Cr | 2 | 80Mo—20Hf | 4 | 50Ru—50Re | 4 | 4214 | 0.84 | 1.11 | 1.55 | 1218 | 41.7 | 8.01 | 20.1 |
| 117 | Cr | 2 | 80Mo—20Ta | 4 | 50Ru—50Re | 4 | 4223 | 0.83 | 1.10 | 1.50 | 1240 | 41.0 | 8.01 | 19.7 |

Subsequently, a magnetic layer 4 was provided. Specifically, a first component layer (thickness: 10 nm) was formed from a CoCrPtB alloy (Co: 60 at %, Cr: 25 at %, Pt: 14 at %, B: 6 at %), and directly thereon, a second component layer (thickness: 10 nm) was formed from a CoCrPtB alloy (Co: 60 at %, Cr: 10 at %, Pt: 15 at %, B: 15 at %).

During the course of formation of the aforementioned layers, Ar was employed as a sputtering gas, and the gas pressure was regulated to 6 mTorr (0.8 Pa). Subsequently, a carbon protective layer 5 (thickness: 3 nm) was formed through CVD. Subsequently, a lubricant containing perfluoropolyether was applied onto the surface of the protective layer 5, to thereby form a lubrication layer 6 (thickness: 2 nm). Thus, a magnetic recording medium 10 was produced.

### TEST EXAMPLES 102 THROUGH 117

The procedure of Test Example 101 was repeated, except that the WZr alloy layer having the aforementioned composition and thickness, which serves as the second component layer of the non-magnetic base layer 2, was replaced by an alloy layer having a composition and thickness shown in Table 6, and that the RuRe alloy layer having the aforementioned composition and thickness, which serves as the non-magnetic intermediate layer 3, was replaced by an alloy layer having a composition and thickness shown in Table 6, to thereby produce a magnetic recording medium 10.

### TEST EXAMPLE 118

A magnetic recording medium 10 was produced by use of alloy layers having compositions and thicknesses shown in Table 7, the layers serving as a non-magnetic base layer 2 and a non-magnetic intermediate layer 3.

Specifically, a glass substrate (outer diameter: 65 mm, inner diameter: 20 mm, thickness: 0.635 mm) was subjected to texturing so as to attain an average surface roughness (Ra) of 0.3 nm. The resultant substrate was employed as a non-magnetic substrate 1. The non-magnetic substrate 1 was placed in a DC magnetron sputtering apparatus (model: C3010, product of ANELVA). Subsequently, the chamber was evacuated so as to attain a vacuum of 2×10⁻⁷ Torr (2.7×10⁻⁵ Pa), and then the non-magnetic substrate 1 was heated to 250° C. On the substrate, an alignment-regulating layer (thickness: 5 nm) was formed from a CrTa alloy (Cr: 65 at %, Ta: 35 at %), followed by heating to 250° C. Subsequently, a non-magnetic base layer 2 was provided on the resultant substrate. The non-magnetic base layer 2 was formed so as to have a multi-layer structure including a first component layer (thickness: 20 nm) formed of RuAl, and a second component layer (thickness: 3 μm) formed of a WZr alloy (W: 80 at %, Zr: 20 at %) and provided on the first component layer. Subsequently, a non-magnetic intermediate layer 3 (thickness: 4 nm) was formed from an RuRe alloy (Ru: 50 at %, Re: 50 at %).

TABLE 7

| | Non-magnetic base layer | | | | | | | | | | | | | |
|---|---|---|---|---|---|---|---|---|---|---|---|---|---|---|
| | First component | | Second component | | Non-magnetic | | | | | | | | | |
| | layer | | layer | | intermediate layer | | Coer- | | | | | | | |
| | | Thick- | | Thick- | | Thick- | cive | Square- | | | | | | |
| Test | Alloy | ness | Alloy | ness | Alloy | ness | force | ness | | | TAA | OW | PW50 | SNR |
| Ex. | composition | nm | composition | nm | composition | nm | Oe | ratio | OR | MrtOR | (μV) | (dB) | (ns) | (dB) |
| 118 | RuAl | 20 | 80W—20Zr | 4 | 50Ru—50Re | 4 | 4140 | 0.80 | 1.11 | 1.46 | 1226 | 41.1 | 8.13 | 19.4 |
| 119 | RuAl | 20 | 80W—20Zr | 4 | Ru | 4 | 4166 | 0.82 | 1.08 | 1.43 | 1183 | 41.9 | 8.25 | 19.4 |
| 120 | RuAl | 20 | 80W—20Zr | 4 | 50Ru—50Rh | 4 | 4215 | 0.81 | 1.10 | 1.46 | 1210 | 41.8 | 8.16 | 19.8 |
| 121 | RuAl | 20 | 80W—20Zr | 4 | 50Ru—50Ir | 4 | 4150 | 0.82 | 1.09 | 1.49 | 1204 | 41.7 | 8.22 | 19.9 |
| 122 | RuAl | 20 | 80W—20Zr | 4 | 80Ru—20Ti | 4 | 4123 | 0.81 | 1.10 | 1.48 | 1199 | 41.8 | 8.21 | 19.7 |
| 123 | RuAl | 20 | 80W—20Zr | 4 | 80Ru—20Nb | 4 | 4152 | 0.80 | 1.08 | 1.52 | 1198 | 41.2 | 8.13 | 19.6 |
| 124 | RuAl | 20 | 80W—20Zr | 4 | 80Ru—20Mo | 4 | 4199 | 0.81 | 1.09 | 1.50 | 1204 | 41.0 | 8.24 | 19.9 |
| 125 | RuAl | 20 | 80W—20Zr | 4 | 80Ru—20W | 4 | 4210 | 0.82 | 1.09 | 1.47 | 1193 | 41.1 | 8.24 | 19.4 |
| 126 | RuAl | 20 | 80W—20Zr | 4 | 80Ru—20Pt | 4 | 4219 | 0.82 | 1.10 | 1.43 | 1234 | 41.1 | 8.14 | 19.7 |
| 127 | RuAl | 20 | 75W—15Zr—5B | 4 | 50Ru—50Re | 4 | 4120 | 0.81 | 1.11 | 1.48 | 1243 | 40.6 | 8.12 | 19.8 |
| 128 | RuAl | 20 | 80W—20Nb | 4 | 50Ru—50Re | 4 | 4182 | 0.81 | 1.10 | 1.43 | 1209 | 41.6 | 8.11 | 19.5 |
| 129 | RuAl | 20 | 80W—20Hf | 4 | 50Ru—50Re | 4 | 4213 | 0.82 | 1.10 | 1.49 | 1246 | 41.8 | 8.22 | 19.3 |
| 130 | RuAl | 20 | 80W—20Ta | 4 | 50Ru—50Re | 4 | 4122 | 0.78 | 1.07 | 1.46 | 1245 | 41.6 | 8.24 | 19.5 |
| 131 | RuAl | 20 | 80Mo—20Zr | 4 | 50Ru—50Re | 4 | 4150 | 0.79 | 1.08 | 1.47 | 1202 | 41.5 | 8.20 | 19.6 |
| 132 | RuAl | 20 | 80Mo—20Nb | 4 | 50Ru—50Re | 4 | 4143 | 0.82 | 1.09 | 1.45 | 1186 | 41.8 | 8.14 | 19.6 |
| 133 | RuAl | 20 | 80Mo—20Hf | 4 | 50Ru—50Re | 4 | 4129 | 0.82 | 1.09 | 1.53 | 1236 | 41.6 | 8.17 | 19.7 |
| 134 | RuAl | 20 | 80Mo—20Ta | 4 | 50Ru—50Re | 4 | 4152 | 0.82 | 1.10 | 1.50 | 1219 | 41.5 | 8.15 | 19.7 |

Subsequently, a magnetic layer 4 was provided. Specifically, a first component layer (thickness: 10 nm) was formed from a CoCrPtB alloy (Co: 60 at %, Cr: 25 at %, Pt: 14 at %, B: 6 at %), and directly thereon, a second component layer (thickness: 10 nm) was formed from a CoCrPtB alloy (Co: 60 at %, Cr: 10 at %, Pt: 15 at %, B: 15 at %).

During the course of formation of the aforementioned layers, Ar was employed as a sputtering gas, and the gas pressure was regulated to 6 mTorr (0.8 Pa). Subsequently, a carbon protective layer 5 (thickness: 3 nm) was formed through CVD. Subsequently, a lubricant containing perfluoropolyether was applied onto the surface of the protective layer 5, to thereby form a lubrication layer 6 (thickness: 2 μm). Thus, a magnetic recording medium 10 was produced.

### TEST EXAMPLES 119 THROUGH 134

The procedure of Test Example 118 was repeated, except that the WZr alloy layer having the aforementioned composition and thickness, which serves as the second component layer of the non-magnetic base layer 2, was replaced by an alloy layer having a composition and thickness shown in Table 7, to thereby produce a magnetic recording medium 10.

### TEST EXAMPLES 135 THROUGH 140

The procedure of Test Example 1 was repeated, except that the WZr alloy layer having the aforementioned composition and thickness, which serves as the second component layer of the non-magnetic base layer 2, was replaced by an alloy layer having a composition and thickness shown in Table 8, and that the RuRe alloy layer having the aforementioned composition and thickness, which serves as the non-magnetic intermediate layer 3, was replaced by an alloy layer having a composition and thickness shown in Table 8, to thereby produce a magnetic recording medium 10.

TABLE 8

Non-magnetic base layer

| | | |
|---|---|---|
| First component | Second component | Non-magnetic |
| layer | layer | intermediate layer |

| Test | Alloy | Thickness | Alloy | Thickness | Alloy | Thickness |
|---|---|---|---|---|---|---|
| Ex. | composition | nm | composition | nm | composition | nm |
| 135 | Cr | 2 | 80W—20Zr | 0.5 | 50Ru—50Re | 4 |
| 136 | Cr | 2 | 80W—20Zr | 12 | 50Ru—50Re | 4 |
| 137 | Cr | 2 | 40W—60Zr | 4 | 50Ru—50Re | 4 |
| 138 | Cr | 2 | 80W—20Zr | 4 | 10Ru—90Re | 4 |
| 139 | Cr | 2 | 80Cr—20Mo | 4 | 50Ru—50Re | 4 |
| 140 | Cr | 2 | 75Cr—20Mo—5B | 4 | 50Ru—50Re | 4 |
| 141 | Cr | 2 | 80Cr—20Mo | 4 | 70Co—28Cr—2Ta | 2 |
| 142 | Cr | 2 | 75Cr—20Mo—5B | 4 | 70Co—28Cr—2Ta | 2 |
| 143 | Cr | 2 | 80Cr—20Mo | 4 | 50Ru—50Re | 4 |
| 144 | Cr | 2 | 75Cr—20Mo—58 | 4 | 50Ru—50Re | 4 |
| 145 | Cr | 2 | 80Cr—20Mo | 4 | 70Co—28Cr—2Ta | 2 |
| 146 | Cr | 2 | 75Cr—20Mo—5B | 4 | 70Co—28Cr—2Ta | 2 |
| 147 | RuAl | 20 | 80Cr—20Mo | 4 | 50Ru—50Re | 4 |
| 148 | RuAl | 20 | 75Cr—20Mo—5B | 4 | 50Ru—50Re | 4 |
| 149 | RuAl | 20 | 80Cr—20Mo | 4 | 70Co—28Cr—2Ta | 2 |
| 150 | RuAl | 20 | 75Cr—20Mo—5B | 4 | 70Co—28Cr—2Ta | 2 |

| | Coercive | | | | | | | |
|---|---|---|---|---|---|---|---|---|
| Test | force | Squareness | | | TAA | OW | PW50 | SNR |
| Ex. | Oe | ratio | OR | MrtOR | (μV) | (dB) | (ns) | (dB) |
| 135 | 3781 | 0.77 | 1.05 | 1.45 | 1124 | 43.2 | 8.45 | 16.9 |
| 136 | 4521 | 0.83 | 1.11 | 1.65 | 1348 | 38.2 | 8.21 | 18.9 |
| 137 | 4214 | 0.81 | 1.07 | 1.54 | 1289 | 41.4 | 8.21 | 19.1 |
| 138 | 4231 | 0.80 | 1.08 | 1.53 | 1278 | 41.2 | 8.26 | 19.0 |
| 139 | 3671 | 0.76 | 1.06 | 1.46 | 1104 | 43.5 | 8.34 | 17.2 |
| 140 | 3587 | 0.75 | 1.07 | 1.41 | 1141 | 43.6 | 8.41 | 16.7 |
| 141 | 4256 | 0.81 | 1.11 | 1.65 | 1361 | 39.2 | 8.21 | 19.1 |
| 142 | 4215 | 0.80 | 1.11 | 1.63 | 1355 | 39.6 | 8.20 | 19.3 |
| 143 | 3563 | 0.57 | 1.04 | 1.21 | 989 | 43.1 | 8.75 | 15.1 |
| 144 | 3411 | 0.58 | 1.04 | 1.24 | 1012 | 41.6 | 8.82 | 14.6 |
| 145 | 4101 | 0.79 | 1.07 | 1.43 | 1187 | 41.2 | 8.23 | 18.6 |
| 146 | 4132 | 0.78 | 1.08 | 1.42 | 1156 | 42.6 | 8.21 | 18.4 |
| 147 | 3562 | 0.53 | 1.04 | 1.21 | 978 | 43.1 | 8.90 | 15.3 |
| 148 | 3466 | 0.55 | 1.03 | 1.20 | 1021 | 43.2 | 8.85 | 14.7 |
| 149 | 4190 | 0.77 | 1.07 | 1.45 | 1189 | 41.5 | 8.24 | 18.0 |
| 150 | 4210 | 0.78 | 1.08 | 1.43 | 1143 | 41.9 | 8.21 | 17.9 |

### TEST EXAMPLES 141 AND 142

The procedure of Test Example 1 was repeated, except that the WZr alloy layer having the aforementioned composition and thickness, which serves as the second component layer of the non-magnetic base layer 2, was replaced by an alloy layer having a composition shown in Table 8, and that the RuRe alloy layer, which serves as the non-magnetic intermediate layer, was replaced by a CoCrTa alloy (Co: 70 at %, Cr: 28 at %, Ta: 2 at %) layer, to thereby produce a magnetic recording medium.

### TEST EXAMPLES 143 AND 144

The procedure of Test Example 101 was repeated, except that the WZr alloy layer having the aforementioned composition and thickness, which serves as the second component layer of the non-magnetic base layer, was replaced by an alloy layer having a composition and thickness shown in Table 8, to thereby produce a magnetic recording medium.

### TEST EXAMPLES 145 AND 146

The procedure of Test Example 101 was repeated, except that the WZr alloy layer having the aforementioned composition and thickness, which serves as the second component layer of the non-magnetic base layer, was replaced by an alloy layer having a composition shown in Table 8, and that the RuCr alloy layer, which serves as the non-magnetic intermediate layer, was replaced by a CoCrTa alloy (Co: 70 at %, Cr: 28 at %, Ta: 2 at %) layer, to thereby produce a magnetic recording medium.

### TEST EXAMPLES 147 AND 148

The procedure of Test Example 118 was repeated, except that the WZr alloy layer having the aforementioned composition and thickness, which serves as the second component layer of the non-magnetic base layer, was replaced by an alloy layer having a composition and thickness shown in Table 8, to thereby produce a magnetic recording medium.

### TEST EXAMPLES 149 AND 150

The procedure of Test Example 118 was repeated, except that the WZr alloy layer having the aforementioned composition and thickness, which serves as the second component layer of the non-magnetic base layer, was replaced by an alloy layer having a composition shown in Table 8, and that the RuRe layer, which serves as the non-magnetic intermediate layer, was replaced by a CoCrTa alloy (Co: 70 at %, Cr: 28 at %, Ta: 2 at %) layer, to thereby produce a magnetic recording medium.

### TEST EXAMPLES 151 AND 152

The procedure of Test Example 84 was repeated, except that the WZr alloy layer having the aforementioned composition and thickness, which serves as the second component layer of the non-magnetic base layer, was replaced by an alloy layer having a composition shown in Table 9, to thereby produce a magnetic recording medium.

### TEST EXAMPLES 153 AND 154

The procedure of Test Example 84 was repeated, except that the WZr alloy layer having the aforementioned composition and thickness, which serves as the second component layer of the non-magnetic base layer, was replaced by an alloy layer having a composition shown in Table 9, and that the CoCrPtTa alloy layer, which serves as the stabilization layer, was replaced by a CoCrTa alloy (Co: 77 at %, Cr: 20 at %, Ta: 3 at %) layer, to thereby produce a magnetic recording medium 11.

TABLE 9

Non-magnetic base layer

| | | |
|---|---|---|
| First component | Second component | |
| layer | layer | Stabilization layer |

| Test | Alloy | Thickness | Alloy | Thickness | Alloy | Thickness |
|---|---|---|---|---|---|---|
| Ex. | composition | nm | composition | nm | composition | nm |
| 151 | Cr | 2 | 80Cr—20Mo | 4 | 67Co—20Cr—10Pt—3Ta | 3 |
| 152 | Cr | 2 | 75Cr—20Mo—5B | 4 | 67Co—20Cr—10Pt—3Ta | 3 |
| 153 | Cr | 2 | 80Cr—20Mo | 4 | 77Co—20Cr—3Ta | 3 |
| 154 | Cr | 2 | 75Cr—20Mo—5B | 4 | 77Co—20Cr—3Ta | 3 |

| | Coercive | | | | | | | |
|---|---|---|---|---|---|---|---|---|
| Test | force | Squareness | | | TAA | OW | PW50 | SNR |
| Ex. | Oe | ratio | OR | MrtOR | (μV) | (dB) | (ns) | (dB) |
| 151 | 3787 | 0.59 | 1.06 | 1.43 | 1056 | 42.5 | 8.65 | 16.3 |
| 152 | 3561 | 0.61 | 1.05 | 1.41 | 1078 | 41.8 | 8.54 | 15.9 |
| 153 | 4291 | 0.81 | 1.11 | 1.68 | 1256 | 40.1 | 8.24 | 19.1 |
| 154 | 4310 | 0.82 | 1.12 | 1.67 | 1268 | 40.2 | 8.26 | 19.3 |

Tables 1 through 9 show the results of evaluations of coercive force (Hc), squareness ratio, magnetic anisotropy index (OR), magnetic anisotropy index of residual magnetization (MrtOR), and read-write conversion characteristics of the magnetic recording media of Examples 1 through 154.

As is clear from the results of Test Examples 1 through 83, 135, and 136, when the second component layer formed of a WZr, WNb, WHf, WTa, MoZr, MoNb, MoHf, or MoTa alloy is combined with the non-magnetic intermediate layer formed of Ru or an RuNb, RuMo, RuRh, RuTa, RuW, RuRe, RuIr, or RuPt alloy, SNR is improved as compared with the case of Test Example 140 in which the second component layer formed of a CrMoB alloy is combined with the non-magnetic intermediate layer formed of RuRe. In Test Example 140; i.e., in the case of employment of a CrMoB alloy, which is generally employed for producing magnetic recording media, characteristics are significantly deteriorated, since a CrMoB alloy has a lattice constant smaller than that of, for example, a WZr alloy (e.g., 2.94 Å for Cr20Mo), and thus RuRe fails to be sufficiently epitaxially grown along a (110) direction.

In Test Example 139; i.e., in the case of employment of a CrMo alloy, which is generally employed for producing magnetic recording media, characteristics are significantly deteriorated as compared with the cases of Test Examples 1 through 83, since a CrMo alloy has a lattice constant smaller than that of, for example, a WZr alloy (e.g., 2.94 Å for Cr20Mo), and thus RuRe fails to be sufficiently epitaxially grown along a (110) direction.

In the case where the second component layer is formed of a CrMo or CrMoB alloy, generally, a CoCrTa alloy is employed as shown in Test Example 141 or 142. However, also in such a case, SNR is lowered as compared with the cases of Test Examples 1 through 83.

As shown in Test Example 12, addition of B to a WZr alloy is effective for improving SNR.

In Test Examples 1 through 83, in which the thickness of the second component layer falls within a range of 2 to 6 nm, SNR is effectively improved as compared with the case of Test Example 135 or 136, in which the thickness of the second component layer is respectively 0.5 nm or 12 nm.

In Test Examples 1 through 47, in which the W content of a WX-based alloy falls within a range of 50 to 99 at %, or in Test Examples 48 through 83, in which the Mo content of an MoX-based alloy falls within a range of 50 to 99 at %, SNR is effectively improved as compared with the case of Test Example 137.

In Test Examples 1 through 83, in which the Ru content of an RuY-based alloy constituting the non-magnetic intermediate layer falls within a range of 20 to 99 at %, SNR is effectively improved as compared with the case of Test Example 138.

Test Examples 84 through 100 are the cases where an AFC medium employs a combination of a WZr, WNb, WHf, WTa, MoZr, MoNb, MoHf, or MoTa alloy and Ru or an RuNb, RuMo, RuRh, RuTa, RuW, RuRe, RuIr, or RuPt alloy. In any of these cases, characteristics are superior to those in the cases of Test Examples 151 through 154. In Test Example 151 or 152; i.e., in the case of employment of a CrMo or CrMoB alloy, which is generally employed for producing magnetic recording media, characteristics are significantly deteriorated, since a CrMo or CrMoB alloy has a lattice constant smaller than that of, for example, a WZr alloy, and thus a CoCrPtTa alloy fails to be sufficiently epitaxially grown along a (110) direction. In the case where a CrMo or CrMoB alloy is employed, generally, a CoCrTa alloy is employed as shown in Test Example 153 or 154. However, also in such a case, SNR is lowered as compared with the cases of Test Examples 84 through 100.

Test Examples 101 through 117 are the cases where a medium including a glass substrate serving as the non-magnetic substrate 1 employs a combination of a WZr, WNb, WHf, WTa, MoZr, MoNb, MoHf, or MoTa alloy and Ru or an RuNb, RuMo, RuRh, RuTa, RuW, RuRe, RuIr, or RuPt alloy. In any of these cases, characteristics are superior to those in the cases of Test Examples 143 through 146. In Test Example 143 or 144; i.e., in the case of employment of a CrMo or CrMoB alloy, which is generally employed for producing magnetic recording media, characteristics are significantly deteriorated, since a CrMo or CrMoB alloy has a lattice constant smaller than that of, for example, a WZr alloy, and thus RuRe fails to be sufficiently epitaxially grown along a (110) direction. In the case where a CrMo or CrMoB alloy is employed, generally, a CoCrTa alloy is employed as shown in Test Example 145 or 146. However, also in such a case, SNR is lowered as compared with the cases of Test Examples 101 through 117.

Test Examples 118 through 134 are the cases where a medium including a glass substrate serving as the non-magnetic substrate 1 employs RuAl in place of Cr, and employs a combination of a WZr, WNb, WHf, WTa, MoZr, MoNb, MoHf, or MoTa alloy and Ru or an RuNb, RuMo, RuRh, RuTa, RuW, RuRe, RuIr, or RuPt alloy. In any of these cases, characteristics are superior to those in the cases of Test Examples 147 through 150. In Test Example 147 or 148; i.e., in the case of employment of a CrMo or CrMoB alloy, which is generally employed for producing magnetic recording media, characteristics are significantly deteriorated, since a CrMo or CrMoB alloy has a lattice constant smaller than that of, for example, a WZr alloy, and thus RuRe fails to be sufficiently epitaxially grown along a (110) direction. In the case where a CrMo or CrMoB alloy is employed, generally, a CoCrTa alloy is employed as shown in Test Example 149 or 150. However, also in such a case, SNR is lowered as compared with the cases of the Test Examples.

1. A magnetic recording medium comprising a non-magnetic substrate; and, on the substrate, at least a non-magnetic base layer, a non-magnetic intermediate layer, a magnetic layer, and a protective layer, the layers being provided in this sequence, characterized in that at least one layer constituting the non-magnetic base layer is formed of a WX-based alloy or an MoX-based alloy (X═Zr, Nb, Hf, or Ta).

2. A magnetic recording medium comprising a non-magnetic substrate; and, on the substrate, at least a non-magnetic base layer, a non-magnetic intermediate layer, a stabilization layer, a non-magnetic coupling layer, a magnetic layer, and a protective layer, the layers being provided in this sequence, and the stabilization layer being antiferromagnetically coupled with the magnetic layer, characterized in that at least one layer constituting the non-magnetic base layer is formed of a WX-based alloy or an MoX-based alloy (X═Zr, Nb, Hf, or Ta).

3. A magnetic recording medium according to claim 1, wherein at least one layer constituting the non-magnetic intermediate layer is formed of Ru or an RuY alloy (Y═Ti, Nb, Mo, Rh, Ta, W, Re, Ir, or Pt).

4. A magnetic recording medium according to claim 1, wherein the WX-based alloy has a W content of 50 to 99 at %, and an X content of 1 to 50 at %.

5. A magnetic recording medium according to claim 1, wherein the MoX-based alloy has an Mo content of 50 to 99 at %, and an X content of 1 to 50 at %.

6. A magnetic recording medium according to claim 3, wherein the RuY-based alloy has an Ru content of 20 to 99 at %, and an X content of 1 to 80 at %.

7. A magnetic recording medium according to claim 2, wherein the non-magnetic coupling layer is formed of any one species selected from among Ru, Rh, Ir, Cr, Re, an Ru-based alloy, an Rh-based alloy, an Ir-based alloy, a Cr-based alloy, and an Re-based alloy, and the non-magnetic coupling layer has a thickness of 0.5 to 1.5 nm.

8. A magnetic recording medium according to claim 2, wherein the stabilization layer is formed of one or more species selected from among a CoCrZr-based alloy, a CoCrTa-based alloy, a CoRu-based alloy, a CoCrRu-based alloy, a CoCrPtZr-based alloy, a CoCrPtTa-based alloy, a CoPtRu-based alloy, and a CoCrPtRu-based alloy.

9. A magnetic recording medium according to claim 1, wherein the non-magnetic base layer has a multi-layer structure including a layer formed of Cr or an Cr alloy containing Cr and one or more species selected from among Ti, Mo, Al, Ta, W, Ni, B, Si, Mn, and V, and a layer formed of a WX-based alloy or an MoX-based alloy (X═Zr, Nb, Hf, or Ta).

10. A magnetic recording medium according to claim 1, wherein the magnetic layer is formed of one or more species selected from among a CoCrTa-based alloy, a CoCrPtTa-based alloy, a CoCrPtB-based alloy, and a CoCrPtBM-based alloy (M: one or more species selected from among Ta, Cu, and Ag).

11. A magnetic recording medium according to claim 1, wherein the non-magnetic substrate is any one species selected from among a glass substrate and a silicon substrate.

12. A magnetic recording medium according to claim 1, wherein the non-magnetic substrate includes a substrate base formed of any one species selected from among Al, an Al alloy, glass, and silicon, and an NiP or NiP alloy film formed on the surface of the substrate base.

13. A magnetic recording medium according to claim 1, wherein the layer formed of a WX-based alloy or an MoX-based alloy (X═Zr, Nb, Hf, or Ta) has a thickness of 0.5 to 12 nm.

14. A process for producing a magnetic recording medium comprising a non-magnetic substrate; and, on the substrate, at least a non-magnetic base layer, a non-magnetic intermediate layer, a magnetic layer, and a protective layer, the layers being provided in this sequence, characterized in that the process comprises forming at least one layer constituting the non-magnetic base layer from a WX-based alloy or an MoX-based alloy (X═Zr, Nb, Hf, or Ta).

15. A process for producing a magnetic recording medium comprising a non-magnetic substrate; and, on the substrate, at least a non-magnetic base layer, a stabilization layer, a non-magnetic coupling layer, a magnetic layer, and a protective layer, the layers being provided in this sequence, and the stabilization layer being antiferromagnetically coupled with the magnetic layer, characterized in that the process comprises forming at least one layer constituting the non-magnetic base layer from a WX-based alloy or an MoX-based alloy (X═Zr, Nb, Hf, or Ta).

16. A magnetic recording and reproducing apparatus characterized by comprising a magnetic recording medium according to claim 1, and a magnetic head for recording of data onto the medium and for reproduction of the data therefrom.
